(19) United States
(12) Patent Application Publication
(10) Pub. No.: US 2024/0330335 A1
(43) Pub. Date: Oct. 3, 2024

(54) SYSTEMS, METHODS, AND COMPUTER PROGRAM PRODUCTS FOR SUGGESTING REVISIONS TO AN ELECTRONIC DOCUMENT USING LARGE LANGUAGE MODELS

(71) Applicant: BLACKBOILER, INC., Arlington, VA (US)

(72) Inventors: Jonathan HERR, Washington, DC (US); Daniel P. BRODERICK, Arlington, VA (US); Ryan MANNION, Arlington, VA (US); Daniel Edward SIMONSON, Arlington, VA (US)

(73) Assignee: BLACKBOILER, INC., Arlington, VA (US)

(21) Appl. No.: 18/621,889

(22) Filed: Mar. 29, 2024

Related U.S. Application Data
(60) Provisional application No. 63/456,284, filed on Mar. 31, 2023.

(51) Int. Cl. G06F 16/332; G06F 40/10

(52) U.S. Cl. CPC G06F 16/3329; G06F 40/10

(57) ABSTRACT

Aspects of the present disclosure relate to systems, methods, and computer program products for revising electronic documents, and more particularly, to systems, methods, and computer program products for suggesting edits to an electronic document using large language models (LLMs).

### CROSS-REFERENCE TO RELATED APPLICATIONS

This application is non-provisional of, and claims the priority benefit of, U.S. Prov. Pat. App. No. 63/456,284 filed Mar. 31, 2013. The aforementioned application is hereby incorporated by reference in its entirety.

### TECHNICAL FIELD

Embodiments disclosed herein relate to systems, methods, and computer program products for revising electronic documents, and more particularly, to systems, methods, and computer program products for suggesting edits to an electronic document using large language models (LLMs).

### BACKGROUND

In the related art, revisions to electronic documents are performed primarily manually by a human editor. In the case of an electronic document, such as a legal contract, an editor may choose to make revisions that are similar to past revisions for legal consistency. Likewise, an editor may choose not to make revisions to documents (or its constituent parts) that are similar to past documents. For example, if a particular paragraph was revised in a particular way in a prior similar document, an editor may choose to edit the particular paragraph in the same way. Similarly, an editor may choose to make revisions that are similar to past revision to meet certain requirements.

The related art includes software that performs redlining to indicate differences between an original document and an edited document. Redlining, generally, displays new text as underlined and deleted text as strikethrough.

The related art also includes software, such as Dealmaker by Bloomberg, that compares a document against a database of related documents to create redlines. The software displays, differences between a selected contract or part thereof and the most common contract or part thereof in the Dealmaker database of contracts. For example, the user may want to compare a lease against other leases. Dealmaker allows the user to compare the lease to the most common form of lease within the Dealmaker database and create a simple redline. Likewise, the user can compare a single provision against the most standard form of that provision within the dealmaker database and create a simple redline.

Many problems exist with the prior art. For example, it may be difficult for an editor to know which of many prior documents contained similar language. Similarly, an editor might not have access to all prior documents or the prior documents might be held by many different users. Thus, according to the related art, an editor may need to look at many documents and coordinate with other persons to find similar language. It can be time consuming and burdensome to identify and locate many prior documents and to review changes to similar language even with the related art redlining software. In some cases, previously reviewed documents can be overlooked and the organization would effectively lose the institutional knowledge of those prior revision. In the case of a large organization, there may be many editors and each individual editor may not be aware of edits made by other editors. Identifying similarity with precision can be difficult for an editor to accomplish with consistency.

Additionally, edits made by human editors are limited by the editor's understanding of English grammar and the content of the portions being revised. As such, different human editors may revise the same portion of a document differently, even in view of the same past-documents.

There are also problems with the related art Dealmaker software as it is primarily a comparison tool. Dealmaker can show the lexical differences between a selected document, or part thereof, and the most common form of that document within the Dealmaker database.

Dealmaker, however, does not propose revisions to documents that will make them acceptable to the user. Similarly, Dealmaker considers only a single source for comparison of each reviewed passage. Dealmaker only displays a simple redline between the subject document and the database document. Dealmaker does not consider parts of speech, verb tense, sentence structure, or semantic similarity. Thus Dealmaker may indicate that particular documents and clauses are different when in fact they have the same meaning.

### SUMMARY OF THE INVENTION

Embodiments disclosed herein provide systems, methods, and computer program products for suggesting revisions to an electronic document that substantially obviates one or more of the problems due to limitations and disadvantages of the related art.

Embodiments disclosed herein provide an automated method of suggesting edits to a document.

Embodiments disclosed herein provide a database of previously edited documents.

Embodiments disclosed herein provide an engine to parse and compare a document to previously reviewed documents.

Embodiments disclosed herein provide a system that remembers revisions made to documents and suggests such revisions in view of future similar documents.

Additional features and advantages of embodiments disclosed herein will be set forth in the description which follows, and in part will be apparent from the description, or may be learned by practice of embodiments disclosed herein. The objectives and other advantages of the embodiments disclosed herein will be realized and attained by the structure particularly pointed out in the written description and embodiments hereof as well as the appended drawings.

To achieve these and other advantages and in accordance with the purpose of embodiments disclosed herein, as embodied and broadly described, systems, methods, and computer program products for suggesting revisions to an electronic document using a large language model (LLM) are disclosed.

Large Language Models (LLMs) are foundational machine learning models that use deep learning algorithms to process and understand natural language. These models are trained on massive amounts of text data to learn patterns and entity relationships in the language. LLMs can perform many types of language tasks, such as translating languages, analyzing sentiments, chatbot conversations, and more. They can understand complex textual data, identify entities and relationships between them, and generate new text.

The architecture of LLMs primarily consists of multiple layers of neural networks, like recurrent layers, feedforward layers, embedding layers, and attention layers. These layers work together to process the input text and generate output predictions.

The embedding layer converts each word in the input text into a high-dimensional vector representation. These embeddings capture semantic and syntactic information about the words and help the model to understand the context.

The feedforward layers of LLMs have multiple fully connected layers that apply nonlinear transformations to the input embeddings. These layers help the model learn higher-level abstractions from the input text.

The recurrent layers of LLMs are designed to interpret information from the input text in sequence. These layers maintain a hidden state that is updated at each time step, allowing the model to capture the dependencies between words in a sentence.

The attention mechanism is another important part of LLMs, which allows the model to focus selectively on different parts of the input text. This mechanism helps the model attend to the input text's most relevant parts and generate more accurate predictions.

Examples of LLMs include:
OpenAI ChatGPT.
Google LaMDA, PaLM, BARD, and mT5
NVIDIA Megatron-Turing NLG
Meta OPT-IML
Deepmind Gopher and Chinchilla

### BRIEF DESCRIPTION OF THE DRAWINGS

The accompanying drawings, which are included to provide a further understanding of embodiments disclosed herein and are incorporated in and constitute a part of this specification, illustrate embodiments and together with the description serve to explain the principles of embodiments disclosed herein.

FIG. 1 is a process flowchart for creating a seed database according to exemplary embodiments;

FIG. 2 is a process flowchart for editing a document and updating a seed database according to exemplary embodiments;

FIG. 3 is an illustration of single alignment according to exemplary embodiments;

FIG. 4 is an illustration of multiple alignment according to exemplary embodiments;

FIG. 5 is an illustration of multiple statement alignment according to exemplary embodiments;

FIG. 6 is a process flowchart for generating a similarity score according to exemplary embodiments;

FIG. 7 is an illustration of multiple statement extraction according to exemplary embodiments;

FIG. 8 is a process flowchart for editing a document and updating a seed database according to exemplary embodiments; and

FIG. 9 is a process flowchart for editing a document and updating a seed database according to exemplary embodiments.

FIG. 10 is a block diagram illustrating a system for suggesting revisions to an electronic document, according to some embodiments.

FIG. 11 is a data flow diagram of a document upload process with edit suggestion, according to some embodiments.

FIG. 12 is a process flow chart for editing a SUA and updating a seed database according to some embodiments.

FIG. 13 illustrates an edited document, according to some embodiments.

FIG. 14 is an illustration of a point edit-type alignment according to some embodiments.

FIG. 15 is an illustration of a point edit-type alignment according to some embodiments.

FIG. 16 is an illustration of a span edit-type alignment according to some embodiments.

FIG. 17 is a block diagram illustrating an edit suggestion device, according to some embodiments.

FIG. 18 is a method for suggesting revisions to text data, according to some embodiments.

Like reference numerals in the drawings denote like elements.

### DETAILED DESCRIPTION

Embodiments of the disclosed systems, methods, and computer program products may include tokenizing a document-under-analysis (“DUA”) into a plurality of statements-under-analysis (“SUAs”), selecting a first SUA of the plurality of SUAs, generating a first similarity score for each of a plurality of the original texts, the similarity score representing a degree of similarity between the first SUA and each of the original texts, selecting a first candidate original text of the plurality of the original texts, and creating an edited SUA (“ESUA”) by modifying a copy of the first SUA consistent with a first candidate final text associated with the first candidate original text.

Embodiments of the disclosed systems, methods, and computer program products may include tokenizing a DUA into a plurality of statements-under-analysis (“SUAs”), selecting a first SUA of the plurality of SUAs, generating a first similarity score for each of a plurality of original texts, the first similarity score representing a degree of similarity between the first SUA and each of the original texts, respectively, generating a second similarity score for each of a subset of the plurality of original texts, the second similarity score representing a degree of similarity between the first SUA and each of the subset of the plurality of original texts, respectively, selecting a first candidate original text of the subset of plurality of the original texts, aligning the first SUA with the first candidate original text according to a first alignment, creating an edited SUA (“ESUA”) by modifying a copy of the first SUA consistent with a first candidate final text associated with the first candidate original text.

Embodiments of the disclosed systems, methods, and computer program products may include tokenizing a DUA into a plurality of statements-under-analysis (“SUAs”), selecting a first SUA of the plurality of SUAs, generating a first similarity score for each of a plurality of original texts, the first similarity score representing a degree of similarity between the first SUA and each of the original texts, respectively, generating a second similarity score for each of a subset of the plurality of original texts, the second similarity score representing a degree of similarity between the first SUA and each of the subset of the plurality of original texts, respectively, selecting a first candidate original text of the subset of plurality of the original texts, aligning the first SUA with the first candidate original text according to a first alignment, creating an edited SUA (“ESUA”) by modifying a copy of the first SUA consistent with a first candidate final text associated with the first candidate original text, selecting a second candidate original text of the subset of plurality of the original texts, and modifying the ESUA consistent with a second candidate final text associated with the second candidate original text.

Embodiments of the disclosed systems, methods, and computer program products may include using a large language model (LLM) for editing of an electronic document, such as a contract, with a prompt, such as, for example, “Change the governing law to New York,” “Delete all supersedes language,” “Delete indemnification provision,” “Change term to 2 years,” or “Limit aggregate liability to two times contract amount of the preceding 12 month period,” and may include: (i) chunking the document under analysis (DUA) into paragraphs; sentences; lists; sub sentences; meaningful pieces of text (SUA or sentence under analysis); (ii) providing a seed database of edited and corresponding unedited text; (iii) providing rules, wherein each set of edited and unedited text corresponds to a rule and wherein each rule corresponds to a prompt; (iv) aligning SUAs using a similarity metric against the seed database; (v) inputting the SUA to an LLM with corresponding prompt; (vi) receiving revised SUA generated by the LLM; (vii) suggesting an edit to the DUA based on the difference between the SUA and the revised SUA.

Embodiments of the disclosed systems, methods, and computer program products may include using a large language model (LLM) for editing of an electronic document, such as a contract, with a prompt, such as, for example, “Change the governing law to New York,” “Delete all supersedes language,” “Delete indemnification provision,” “Change term to 2 years,” or “Limit aggregate liability to two times contract amount of the preceding 12 month period,” and may include: (i) chunking the document under analysis (DUA) into paragraphs; sentences; lists; sub sentences; meaningful pieces of text (SUA or sentence under analysis); (ii) providing a seed database of sets of edited and corresponding unedited text; (iii) inputting each set of edited and corresponding unedited text to an LLM to generate a prompt; (iv) providing rules, wherein each set of edited and unedited text corresponds to a rule and wherein each rule corresponds to a prompt; (v) aligning SUAs using a similarity metric against the seed database; (vi) inputting the SUA to an LLM with corresponding prompt; (vii) receiving revised SUA generated by the LLM; (viii) suggesting an edit to the DUA based on the difference between the SUA and the revised SUA.

Embodiments of the disclosed systems, methods, and computer program products may include using a large language model (LLM) for editing of an electronic document, such as a contract, with examples as prompts, and may include: (i) chunking the document under analysis (DUA) into paragraphs; sentences; lists; sub sentences; meaningful pieces of text (SUA or sentence under analysis); (ii) providing a seed database of edited and corresponding unedited text; (iii) aligning SUAs using a similarity metric against the seed database; (iv) inputting all sentences from the seed database that align against the SUA to an LLM to prompt the LLM to edit the SUA; (v) receiving revised SUA generated by the LLM; (vi) suggesting an edit to the DUA based on the difference between the SUA and the revised SUA.

Embodiments of the disclosed systems, methods, and computer program products may include using a large language model (LLM) for editing of an electronic document, such as a contract, using historical examples to make a classifier with a prompt per class, and may include: (i) chunking the document under analysis (DUA) into paragraphs; sentences; lists; sub sentences; meaningful pieces of text (SUA or sentence under analysis); (ii) providing a seed database of sentences and corresponding edited sentences; (iii) clustering edits so that all similar edits are in the same cluster; (iv) identifying a classifier for each cluster, wherein each class corresponds to a prompt; (v) classifying each SUA by comparing each SUA against each classifier; (vi) inputting classified SUA to an LLM with a corresponding prompt; (vii) receiving revised SUA generated by the LLM; (viii) suggesting an edit to the DUA based on the difference between the SUA and the revised SUA.

Embodiments of the disclosed systems, methods, and computer program products may include using a large language model (LLM) for editing of an electronic document, such as a contract, with a prompt, by a user selecting preferred prompts via question and answer (Q&A), and may include: (i) prompting a user to select one or more editing preferences, such as, for example, by prompting the user to indicate “Yes/No” to a prompt, such as “Yes/No: Are arbitration provisions permitted?” or to fill in the blank preference selection, such as “What is the preferred term: (a) 1 year; (b) 2 years; or (c) 3 years?”; (ii) chunking the document under analysis (DUA) into paragraphs; sentences; lists; sub sentences; meaningful pieces of text (SUA or sentence under analysis); (iii) providing a seed database of edited and corresponding unedited text based on the one or more editing preferences selected by the user; (iv) providing rules, wherein each set of edited and unedited text corresponds to a rule and wherein each rule corresponds to a prompt; (v) aligning SUAs using a similarity metric against the seed database; (vi) inputting the SUA to an LLM with corresponding prompt; (vii) receiving revised SUA generated by the LLM; (viii) suggesting an edit to the DUA based on the difference between the SUA and the revised SUA.

Embodiments of the disclosed systems, methods, and computer program products may include using a large language model (LLM) for editing of an electronic document, such as a contract, with examples as prompts, by a user selecting preferred prompts via question and answer (Q&A), and may include: (i) prompting a user to select one or more editing preferences, such as, for example, by prompting the user to indicate “Yes/No” to a prompt, such as “Yes/No: Are arbitration provisions permitted?” or to fill in the blank preference selection, such as “What is the preferred term: (a) 1 year; (b) 2 years; or (c) 3 years?”; (ii) chunking the document under analysis (DUA) into paragraphs; sentences; lists; sub sentences; meaningful pieces of text (SUA or sentence under analysis); (iii) providing a seed database of edited and corresponding unedited text based on the one or more editing preferences selected by the user; (iv) aligning SUAs using a similarity metric against the seed database; (v) inputting all sentences from the seed database that align against the SUA to an LLM to prompt the LLM to edit the SUA; (vi) receiving revised SUA generated by the LLM; (vii) suggesting an edit to the DUA based on the difference between the SUA and the revised SUA.

The embodiments disclosed herein are designed to use many different types of large language models (LLMs) including, but not limited to, the LLMs described in the following (the full text of which is included in the Appendix below):
https://aman.ai/primers/ai/transformers/·
http://www.columbia.edu/˜js12239/transformers.html
http://jalammar.github.io/illustrated-transformer/

It is to be understood that both the foregoing general description and the following detailed description are exemplary and explanatory and are intended to provide further explanation of embodiments disclosed herein.

The embodiments disclosed herein are described, in part, in terms that are unique to the problem being solved. Thus, for the avoidance of doubt, the below descriptions and definitions are provided for clarity. The term DUA means “document under analysis.” A DUA is, generally, a document that is being analyzed for potential revision. A DUA can be, for example, a sales contract that is received by a real estate office. The term SUA means “statement under analysis.” The DUA can be divided into a plurality of statements, and each statement can be called a SUA. The SUA can be analyzed according to the systems and methods described herein to provide suggested revisions to the SUA. Generally speaking, the SUA can be a sentence and the DUA can be tokenized into SUAs based on sentence breaks (e.g. periods). The SUA, however, is not limited to sentences and the SUA can be, for example, an entire paragraph or a portion or phrase of larger sentence. The term ESUA means “edited statement under analysis.” The term “sentence” means sentence in the traditional sense, that is, a string of words terminating with a period that would be interpreted as a sentence according to the rules of grammar. The description of embodiments disclosed herein use the word “sentence” without prejudice to the generality of the embodiments disclosed herein. One of skill in the art would appreciate that “sentence” could be replaced with “phrase” or “paragraph” and the embodiments disclosed herein would be equally applicable.

The term “original document” means a document that has not been edited by the methods described herein. The term “final document” means the final version of a corresponding original document. A final document can be an edited version of an original document. The term “original text” means part of an original document (e.g. a sentence). The term “final text” means part of a final document (e.g. a sentence). A phrase or sentence is “compound” when it includes multiple ideas. For example, the sentence “It is hot and rainy” is compound because it includes two ideas: (1) “It is hot”; and (2) “It is rainy.”

Embodiments disclosed herein can further include a “seed database.” A seed database can be derived from one or more “seed documents” which are generally original documents and final documents. In some instances, a seed document can be both an original document and a final document such as documents that include “track changes” that are common with documents created in Microsoft Word. The original text of each seed document can be can be tokenized into one or more tokens. The final text of each seed document can be tokenized into one or more tokens. Each token of original text can be correlated with its respective final text. The each original text token and its corresponding final text can be stored in the seed database. In some instances, an original text and a final text can be identical, for example when no edits or changes were made. In such instances, the original text and corresponding identical final text can be saved in the seed database.

The term “similarity score” means a value (or relative value) that is generated from the comparison of an SUA and an original text. The similarity score can be, for example, an absolute number (e.g. 0.625 or 2044) or a percentage (e.g. 95%). Multiple methods for generating a similarity score are described herein or are otherwise known in the art and any such method or formula can be used to generate a similarity score.

The term “aligning” or “alignment” means matching the words and phrases of one sentence to another. Words and phrases can be matched according to lexical or semantic similarity. Alignment is frequently imprecise due to variation between sentences. Thus, “alignment” does not necessarily imply a 1:1 correlation between words and, in many cases, alignment is partial.

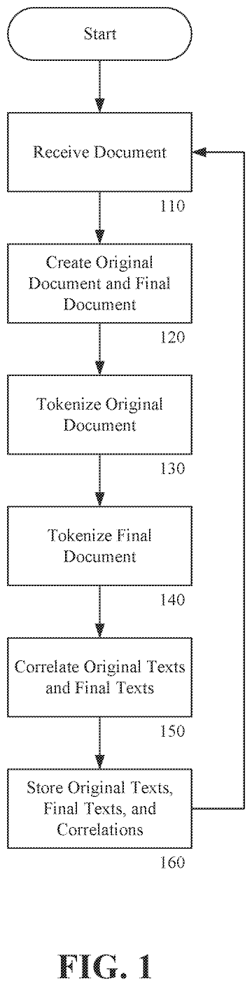

FIG. 1 is a process flowchart for creating a seed database according to embodiments disclosed herein. As shown in FIG. 1, a creating a seed database includes receiving 110 a seed document, creating 120 an original document and a final document, tokenizing 130 the original document, tokenizing 140 the final document, correlating 150 each original texts with a corresponding and final text, and storing 160 each original text, its corresponding final text, and the correlation in the seed database.

In step 110, one or more seed documents can be selected. The seed documents can be for example, Microsoft Word documents. The seed documents can include “track changes” such as underline and strike-through to denote additions and deletions, respectively. In an alternative embodiment, a seed document can be a pair of documents such as original version and an edited version. The seed documents relate to a common subject or share a common purpose such as a commercial leases or professional services contracts. The seed documents can represent documents that have been edited and reviewed from the original text to the final text.

The edits and revisions can embody, for example, the unwritten policy or guidelines of a particular organization. As an example, a company may receive a lease document from a prospective landlord. The original document provided by the landlord may provide “this lease may be terminated by either party on 30-days notice.” The company may have an internal policy that it will only accept leases requiring 60-days notice. Accordingly, in the exemplary lease, an employee of the company may revise the lease agreement to say “this lease may be terminated by either party on 60-days notice.” As a second example, the proposed lease provided by the prospective landlord may include a provision that states “all disputes must be heard in a court in Alexandria, Virginia.” These terms may be acceptable to the company and the company may choose to accept that language in a final version.

In the example of the company, one or more seed documents can be selected in step 110. The seed documents can be for example, commercial leases that have been proposed by prospective landlords and have been edited to include revisions in the form of “track changes” of the apartment rental company. In the alternative, a seed document can comprise two separate documents. The first document can be an original document such as the lease proposed by a prospective landlords. The second document can be an edited version that includes revisions made by the company.

In step optional step 120, a seed document having embedded track changes can be split into two documents. A first document can be an original document and a second document can be a final document.

In step 130, the original text of each original document can be tokenized into a plurality of original texts. The original document can be tokenized according to a variety of hard or soft delimiters. In the simplest form, a token delimiter can be a paragraph. In this example, an original document can be tokenized according to the paragraphs of the document with each paragraph being separated into a distinct token. The original document can also be tokenized according to sentences as indicated by a period mark. Paragraph marks, period marks, and other visible indicia can be called “hard” delimiters. In more complex examples, original document can be tokenized according to “soft” delimiters to create tokens that include only a portion of sentence. A “soft” delimiter can be based on sentence structure rather than a visible indicia. For example, a sentence can be tokenized according to a subject and predicate. In another example, a sentence can be tokenized according to a clause and a dependent clause. In another example, a sentence can be tokenized into a condition and a result such as an if-then statement.

In step 140, the final text of each final document can be tokenized into a plurality of final texts. The tokenization of the final document can be performed in the same manner as described in conjunction with the tokenization of the original document.

In step 150, each original text is correlated to its respective final text. For example, the original text “this lease may be terminated by either party on 30-days notice” can be correlated with the final text “this lease may be terminated by either party on 60-days notice.” In a second example where no changes are made, the original text “all disputes must be heard in a court in Alexandria, Virginia” can be correlated with the final text “all disputes must be heard in a court in Alexandria, Virginia.” In the alternative, the original text of second example can be correlated with flag indicating the original text and the final text are the same. In a third example, where a deletion is made, original text “landlord shall pay all attorneys fees” can be correlated with final text of a null string. In the alternative, the original text of the third example can be correlated with a flag indicating the original text was deleted in its entirety.

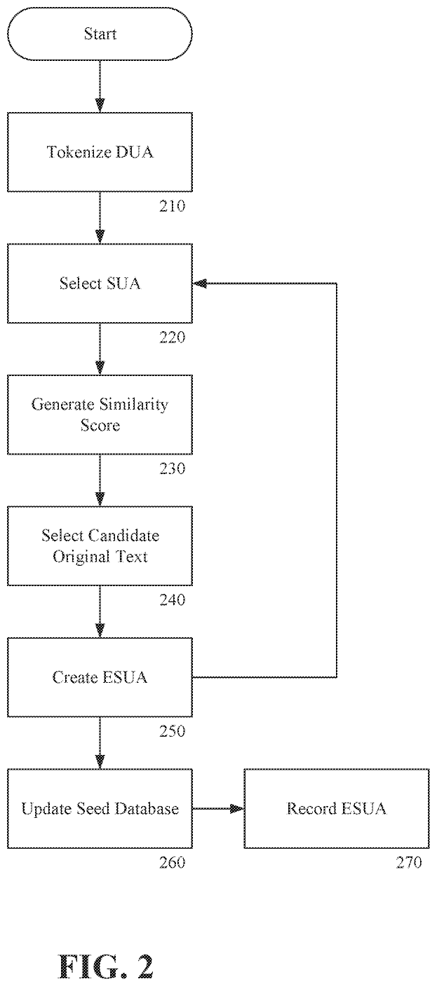

In step 160, each original text, its corresponding final text, and the correlation can be saved in the seed database. The correlation can be explicit or implied. In an explicit correlation, each original text can be stored with additional information identifying its corresponding final text and vice versa. In an exemplary embodiment, each original text and each final text can be given a unique identifier. An explicit correlation can specify the unique identifier of the corresponding original text or final text. A correlation can also be implied. For example, an original text can be stored in the same data structure or database object as a final text. In this instance, although there is not explicit correlation, the correlation can be implied by the proximity or grouping. The seed database can then be used to suggest revisions to future documents as explained in greater detail in conjunction with FIG. 2.

It is contemplated that a user editor may desire to take advantage of the novel benefits embodiments disclosed herein without having a repository of past documents to prime the seed database. Therefore, embodiments disclosed herein further include a sample database of original text and corresponding final text for a variety of document types. Embodiments disclosed herein can further include a user questionnaire or interview to determine the user's preferences and then load the seed database with portions of the sample database consistent with the user's answers to the questionnaire. For example, a new user may desire to use the embodiments disclosed herein but that particular new user does not have previously edited documents with which to prime the seed database. Embodiments disclosed herein may ask the use questions, such as “will you agree to fee shifting provisions?” If the user answers “yes”, then the seed database can be loaded with original and final text from the sample database that include fee shifting. If the user answers “no”, then the seed database can be loaded with original and final text from the sample database that has original text including fee shifting and final text where fee shifting has been deleted or edited. In another example, a sample question includes “how many days notice do you require to terminate a lease?” If a user answers “60”, then the seed database can be loaded with original and final text from the sample database that has a 60-day lease-termination notice provision, or, as another example, where the original text has N-day termination provisions and the final text has a 60-day termination provision.

FIG. 2 is a process flowchart for editing a document and updating a seed database according to embodiments disclosed herein. As shown in FIG. 2, editing a document and updating a seed database can include tokenizing 210 a DUA (document under analysis), selecting 220 a SUA (statement under analysis), generating 230 similarity scores, selecting 240 a candidate original text, creating 250 an ESUA (edited statement under analysis), updating 260 the seed database, and recording 270 the ESUA.

In step 210, a DUA can be tokenized into a plurality of SUAs. The DUA can be tokenized in the same way as described in conjunction with FIG. 1 with tokenizing the original document and final document in creation of the seed database. The DUA can be selected by a user. The DUA can be an electronic document. The DUA can be proposed legal document such as lease, contract, or agreement. In the example of the apartment rental company, a DUA can be a proposed lease agreement provided by a prospective tenant. The DUA can be selected via a file-chooser dialog. The DUA can be selected via a context-menu. The DUA can be selected via a drop-down menu. The DUA can be selected via plug-in for a document management system or an e-mail program.

In step 220, an SUA can be selected. The SUA can be a first SUA of the DUA In subsequent iterations, successive SUAs can be selected such as the second SUA, the third SUA, and so on. Each SUA can be selected in succession.

In step 230, a similarity score can be generated. The similarity score can represent a degree of similarity between the currently selected SUA and each of the original texts in the seed database.

A similarity score for a given SUA and original text can be calculated by comparing the total number of words or the number of words with similar semantics. In exemplary embodiments disclosed herein, a model of semantically similar words can be used in conjunction with generating the similarity score. For example, the database can specify that “contract” has a similar meaning as “agreement.” The step of calculating a similarity score can further include assessing words with similar semantics. For example, using the model, the SUA “the contract requires X” can be calculated to have a similarity score of nearly 100% similar to the original text “the agreement requires X” in the seed database.

Generating a similarity score can include assigning a lower weight to proper nouns. In other embodiments, generating a similarity score can include ignoring proper nouns. Generating a similarity score can include classifying a SUA based on comparing various parts of the SUA. For example, a SUA's subject, verb, object, and modifiers may be compared to each of the subject, verb, object, and modifiers of the original texts in the seed database. Additionally, modifiers of a SUA with a specific characteristics may be compared to the modifiers of various other original texts that all have the same specific characteristics.

The following is an example of two original texts in an exemplary seed database, the corresponding final texts to those two original texts, a SUA from a DUA, and edits made to the SUA consistent with the final texts.

### Original Text 1:

“Contractor shall submit a schedule of values of the various portions of the work.” Noun: (nominal subject) Contractor

Verb: Submit

Noun: (direct object) Schedule Corresponding Final Text 1:

“Contractor shall submit a schedule of values allocating the contract sum to the various portions of the work.”

### Original Text 2:

“Contractor shall submit to Owner for approval a schedule of values immediately after execution of the Agreement.”

Noun: (nominal subject) Contractor

Verb: Submit

Noun: (direct object) Schedule

### Final Text 2:

“Contractor shall submit to Owner for prompt approval a schedule of values prior to the first application for payment.”

### SUA:

“Immediately after execution of the Agreement, Contractor shall submit to Owner for approval a schedule of values of the various portions of the work.”

Noun: (nominal subject) Contractor

Verb: Submit

Noun: (direct object) Schedule

### Edited SUA:

“Prior to the first application for payment, Contractor shall submit to Owner for prompt approval a schedule of values allocating the contract sum to the various portions of the work.”

In the above example, all the sentences contained the same nominal subject, verb, and direct object. The embodiments disclosed herein can classify these sentences based upon the similarity of the nominal subject, verb, and direct object as having a high similarity. The embodiments disclosed herein then compare the other parts of the SUA to the original text from Original Text 1 and 2 and made corresponding edits to the similar portions of the DUA sentence.

Generating a similarity score can include assigning a lower weight to insignificant parts of speech. For example, in the phrase, “therefore, Contractor shall perform the Contract” the word “therefore” can be assigned a lower weight in assessing similarity.

Generating a similarity score can include stemming words and comparing the stems. For example, the words, “argue”, “argued”, “argues”, “arguing”, and “argus” reduce to the stem “argu” and the stem “argue” could be used for the purpose of generating a similarity score.

The similarity score can be generated according to well-known methods in the art. The similarity score can be a cosine similarity score, a clustering metric, or other well-known string similarity metrics such as Jam-Winkler, Jaccard or Levenshtein. In preferred embodiments a similarity score is a cosine similarity score that represents the degree of lexical overlap between the selected SUA and each of the original texts. A cosine similarity score can be computationally fast to calculate in comparison to other similarity scoring methods. A cosine similarity score can be calculated according to methods known in the art, such as described in U.S. Pat. No. 8,886,648 to Procopio et. al the entirety of which is hereby incorporated by reference. A cosine similarity score can have a range between 0 and 1 where scores closer to 1 can indicate a high degree of similarity and scores closer to 0 can indicate a lower degree of similarity.

A clustering algorithm can plot a loose association of related strings in two or more dimensions and use their distance in space as a similarity score. A string similarity metric can provide an algorithm specific indication of distance (‘inverse similarity’) between two strings.

In step 240, a candidate original text can be selected. The candidate original text can be the original text having the best similarity score calculated in step 230. As used herein, the term “best” can mean the similarity score indicating the highest degree of similarity. In the alternative, a threshold cut-off can be implemented and a second criteria can be used to perform the selection of step 240. For example, a threshold cut-off can be all similarity scores that exceed a predetermined level such as “similarity scores greater than 0.65”. In another example, a threshold cut-off can be a predetermined number of original texts having the best similarity score such as the “top 3” or the “top 5.” In an exemplary threshold cut-off only scores that exceed the threshold cut-off are considered for selection in step 240. The selection can include selecting the original text having the best similarity score. The section can include choosing the original text having the largest number of similar words to the SUA. The selection can include choosing the original text having the largest identical substring with the SUA. Subsequent selections under step 240 can omit previously selected original texts.

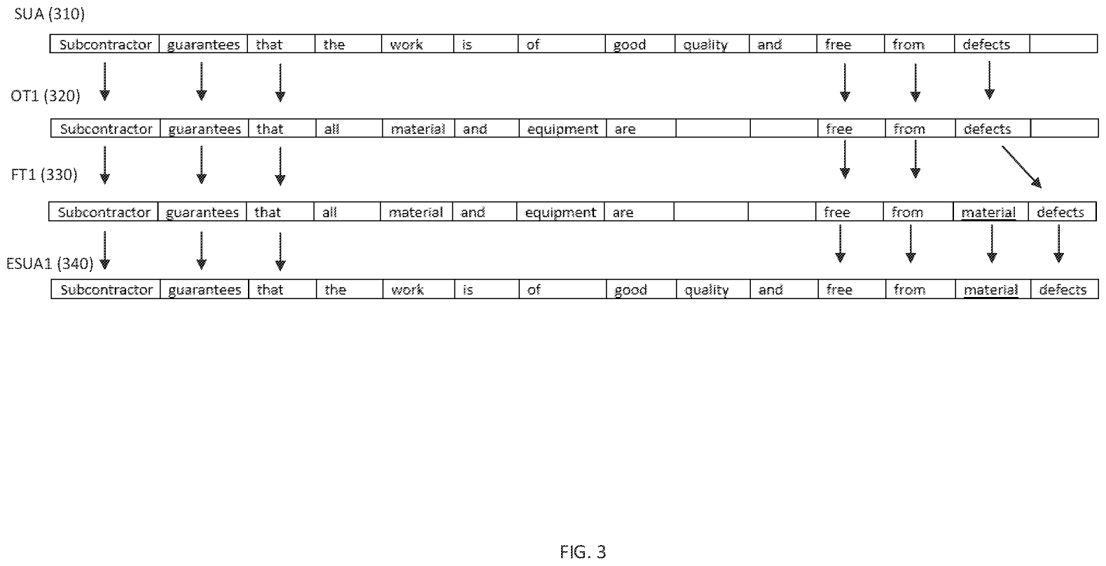

In step 250, an ESUA (edited statement under analysis) can be created. The ESUA can be created by applying the same edits from a final text associated with the candidate original text to the SUA. The process of applying the edits is described in more particularity in conjunction with discussion of alignment in FIG. 3-FIG. 5. After step 250, the process can transition back to step 220 where another SUA is selected. If there are no more SUAs, the process can transition to step 260 wherein the seed database is update.

Although not shown in FIG. 2, an optional step (not shown) can occur before the update the seed database step 260. In the optional step (not shown) the ESUAs can be displayed to a user for approval and confirmation. A user can further edit the ESUAs according to preference or business and legal objectives. The SUA and the ESUA (including any user-entered revisions thereto) can be stored in the seed database in step 260.

In step 260, the seed database can be updated by saving the SUAs and the corresponding ESUAs. In this way, the seed database grows with each DUA and edits made to an SUA will be retained in the institutional knowledge of the seed database.

In step 270, the ESUAs can be recorded. In a first example, the ESUAs can be recorded at the end of the DUA in an appendix. The appendix can specify amendments and edits to the DUA In this way, and original words of the DUA are not directly edited, but an appendix specifies the revised terms. This first method of recording the ESUAs can be utilized when the DUA is a PDF document that cannot easily be edited. In a second example, the ESUA can be recorded in-line in the DUA Each ESUA can be used to replace the corresponding SUA In embodiments disclosed herein, the ESUA can be inserted in place of the SUA with “track changes” indicating the edits being made. This second method of recording the ESUAs can be utilized when the DUA is in an easily editable format such as Microsoft Word. In a third example, the ESUAs can be recorded in a separate document than the DUA The separate document can be an appendix maintained as a separate file. The separate document can refer to the SUAs of the DUA and identify corresponding ESUAs. This third method can be utilized when the DUA is a locked or secured document that does not allow editing.

FIG. 3 is an illustration of single alignment according to embodiments disclosed herein. As shown in FIG. 3, single alignment includes aligning an SUA 310 to an original text “OT1” 320, aligning a corresponding final text “FT1” 330 to the original text 320 and finally creating the ESUA 340. The illustration of FIG. 3 is described as a “single alignment” because the SUA 310 is aligned with OT1 320 one time. To align the SUA 310 and the OT1 320, each word of the SUA 310 is matched to a corresponding word of the OT1 320, where applicable. In the example of FIG. 3, the words “subcontractor guarantees that” in the SUA 310 are the same as the words “subcontractor guarantees that” of the OT1 320. These words are denoted as “aligned” by the arrows extending therebetween. The next words of the SUA 310 “the work is of good quality and”, however, have no corresponding words in the OT1 320. These words cannot be aligned. Finally, the words “free from defects” in the SUA 310 are matched to the words “free from defects” in the OT1 320 completing the alignment of the SUA 310 to the OT1 320. In this example, only six of the words matched, but the SUA 310 and the OT1 320 are nevertheless described as aligned.

While the example of FIG. 3 illustrates alignment by correlating identical words, the embodiments disclosed herein is not limited to identical words. Alignment according to the embodiments disclosed herein further contemplates alignment of similar words such as synonyms or words that are interchangeable in context such as “guarantees” and “warrants.” A word embedding model can be used to align sentences having similar meanings although they have few words in common.

Word embedding is the collective name for a set of language modeling and feature learning techniques in natural language processing (NLP) where words or phrases from the vocabulary are mapped to vectors of real numbers in a low-dimensional space relative to the vocabulary size (“continuous space”). A word embedding model can be generated by learning how words are used in context by reading many millions of samples. By training the model on domain relevant text, a word embedding model can be built which effectively understands how words are used within that domain, thereby providing a means for determining when two words are equivalent in a given context. Methods to generate this mapping include neural networks, dimensionality reduction on the word co-occurrence matrix, probabilistic models, and explicit representation in terms of the context in which words appear. Word and phrase embeddings, when used as the underlying input representation, boost the performance in NLP tasks such as syntactic parsing and sentiment analysis.

Word2vec is an exemplary word embedding toolkit which can train vector space models. A method named Item2Vec provides scalable item-item collaborative filtering. Item2Vec is based on word2vec with minor modifications and produces low dimensional representation for items, where the affinity between items can be measured by cosine similarity. Software for training and using word embeddings includes Tomas Mikolov's Word2vec, Stanford University's GloVe and Deeplearning4j. Principal Component Analysis (PCA) and T-Distributed Stochastic Neighbor Embedding (t-SNE) can both be used to reduce the dimensionality of word vector spaces and visualize word embeddings and clusters.

The alignment of the FT1 330 and the OT1 320 can proceed in the same way as the alignment of OT1 320 with the SUA 310. As shown in FIG. 3, the words of FT1 330 can be matched to the aligned words of the OT1 320.

After the SUA 310, the OT1 320, and the FT1 330 are aligned, the edits from the FT1 330 can be applied to the SUA 310 to create the ESUA 340. In the example of FIG. 3, the word “material” was added to the FT1 330 and, because of the alignment, the word “material” is added in the corresponding location in the SUA 310 to create the ESUA 340.

An expression can be generated that describes the steps to convert the OT1 320 into the FT1 330. The expression can describe, for example, a series of edit operations, such as [Insert 1,3,1,1] to insert words 1-3 from the FT1 330 at position 1 of the OT1 320. A similar expression can be generated that describes the steps to convert the SUA 310 to the OT1 320. The two resulting expressions can be combined to generate a combined expression(s) describing equal subsequences where edits could be applied from the FT1 330 to the SUA 310. Applying the combined expression to the SUA 310 can produce the ESUA 340.

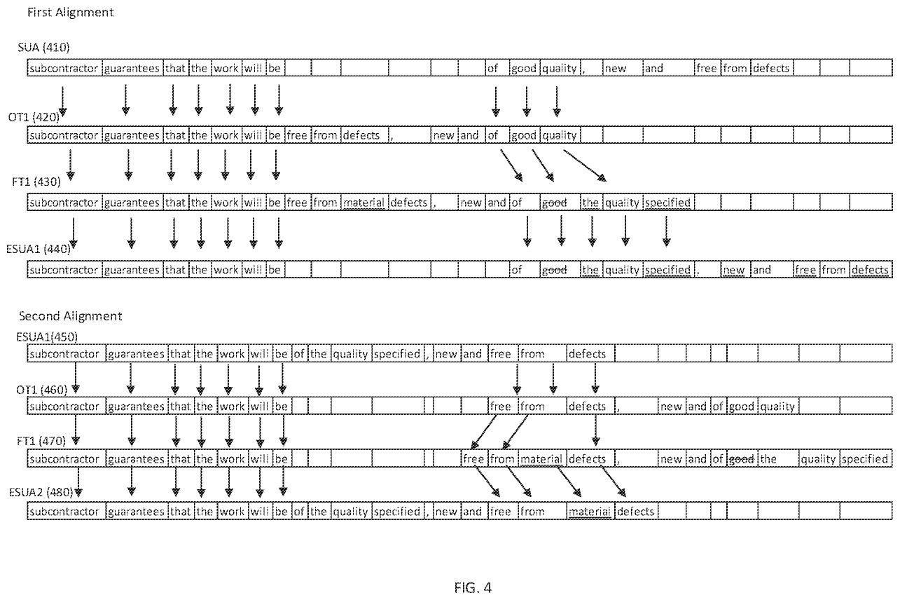

FIG. 4 is an illustration of multiple alignment according to embodiments disclosed herein. As shown in FIG. 4, the SUA 410 and the original text OT1 420 are essentially the same, except that the order of some of the words is changed. In a simplified example, the SUA 410 says “Subcontractor guarantees A, Band C” while the OT1 says “Subcontractor guarantees C, B and A.” As shown in the final text FT1 430, edits were made to the words corresponding to clause C and A in the simplified example. In this case, the OT1 420 can be aligned in more than one way so that the edits of the FT1 430 can be applied to the corresponding clauses A and C of the SUA.

In more detail, in a first alignment, the words “subcontractor guarantees that the work will be” of the SUA 410 are aligned with the same words “subcontractor guarantees that the work will be” of the OT1 420. Similarly, the words “of good quality” are aligned with identical words in the OT1 420. Under this alignment, however, the words “new and free from defects” of the SUA 410, however, do not align with any text in the OT1. Nevertheless, the OT1 420 is considered aligned with the SUA 410.

Next, the final text FT1 (430) is aligned with the OT1 (420) and the edits from the FT1 430 are implemented in the corresponding locations of the SUA 410 to create the ESUA1 440.

It will be noted from this example of a first alignment, that some of the edits from the FT1 (e.g. “free from material defects”) were not aligned under the first alignment and were not implemented in the ESUA1 440. However, examining the ESUA1 440 reveals that the ESUA1 (and the SUA) included words that should have been edited (e.g. “free from defects”). To capture these edits to the FT1 430 in the ESUA 440, a second alignment is performed.

In more detail, a second alignment begins with the ESUA1 450 that was the output ESUA1 440 from the first alignment. In the second alignment of the OT1 (460) with the ESUA1 (450) the words “free from defects” are aligned instead of the “of good quality” as in the first alignment. Next, the FT1 470 is aligned with the OT1 (460) and the edits from the FT1 470 are implemented in the corresponding locations of the ESUA1 450 to create the ESUA2 480.

In summary, as shown in FIG. 4, a first alignment aligns one clause of the SUA 410 (e.g. clause A from the simplified example) to the OT1 420 and corresponding edits of the FT1 430 are applied to the SUA 410 to create the ESUA1 440. Next, a second alignment a second clause of the ESUA1 450 (e.g. clause C from the simplified example) to the OT1 460 and the corresponding edits of the FT1 470 are applied to the ESUA1 450 to create the ESUA2 480.

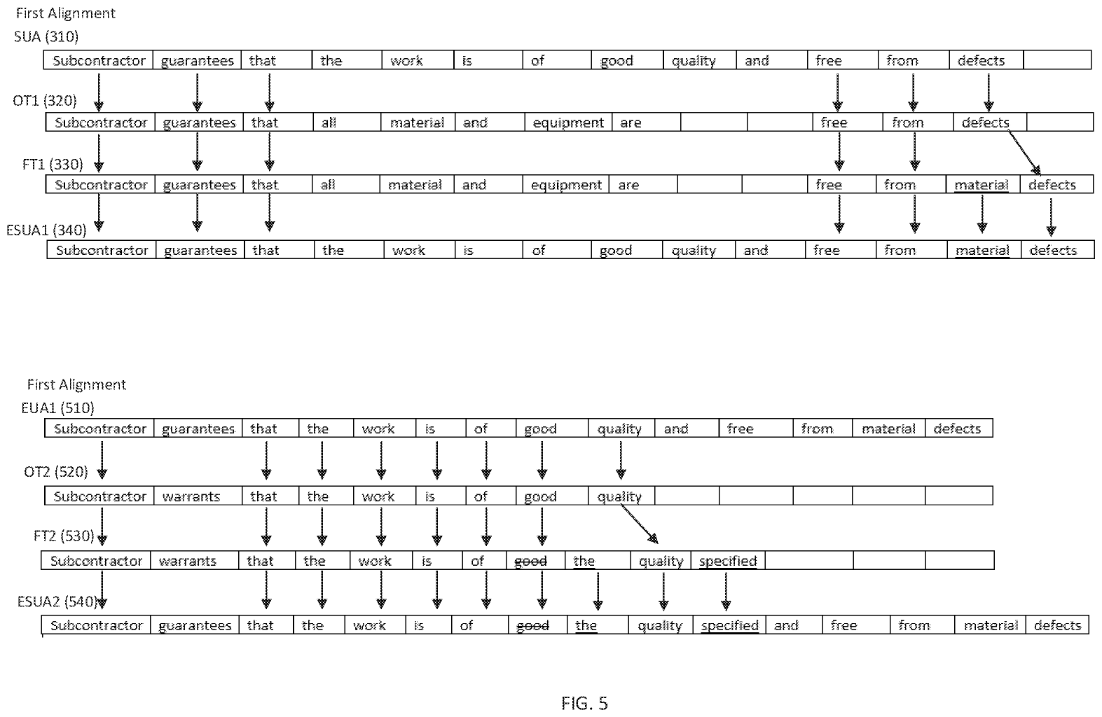

FIG. 5 is an illustration of multiple statement alignment according to embodiments disclosed herein. As shown in FIG. 5 a SUA 310 can be aligned according to a first alignment with a first original text OT1 320. The ESUA1 510 can then be aligned with a second original text OT2 520. The first alignment of FIG. 5 can be the same as described in conjunction with FIG. 3. The OT1 320 can be an original text from the seed database having best a similarity score. The OT2 520 can be an original text from the seed database having a second best similarity score. After the first alignment and edits are performed as described in conjunction with FIG. 3, OT2 520 ca can be selected as a basis to further edit the ESUA1 510. The alignment of the ESUA1 510 with the OT2 520, the alignment of OT2 520 with the correlated final text FT2 530, and the implementation of edits to yield the ESUA2 540 can proceed in the same manner as the first alignment although this time using the ESUA1 540 as a starting point and using the OT2 520 and FT2 530. It should be noted that when two or more original texts having identical or similar edits are used in multi-statement alignment, the identical or similar edits are only applied once (e.g. the term “material” would not be inserted twice.)

Multiple statement alignment according to the embodiments disclosed herein can beneficial when an SUA has high similarity with two or more original texts. By aligning and inserting edits from multiple final texts, the ESUA can more closely resembles prior edits made to similar text. It is contemplated that multiple alignments can be performed on a first original text (as described in conjunction with FIG. 4) and that multiple alignments can be performed with multiple original texts. In more detail, a first original text can be aligned with an SUA according to a first alignment, the first original text can then be aligned with the resultant ESUA according to a second alignment, a second original text can be aligned with the resultant ESUA according to a yet another alignment, and the second original text can be aligned with the resultant ESUA according to a fourth alignment. In this way, the end ESUA has the benefit of edits made to two original texts, each aligned in two different ways. The foregoing example is not limiting and the embodiments disclosed herein contemplates three, four, or more alignments of a single original text with an SUA and further alignment three, four, or more other original texts.

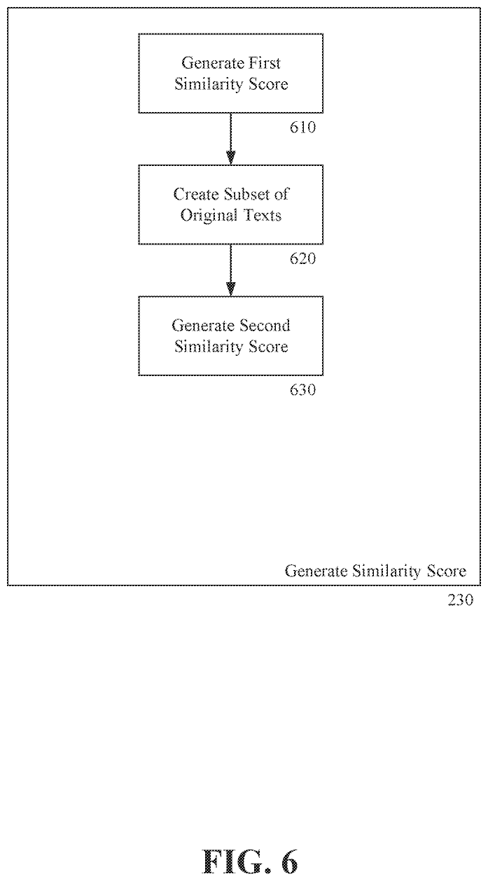

FIG. 6 is a process flowchart for generating a similarity score according to embodiments disclosed herein. As shown in FIG. 6, generating 230 a similarity score can include generating 610 a first similarity score, creating 620 a subset of original texts, and generating 630 a second similarity score. It is contemplated that generation of a similarity score, generally, can be computationally expensive. If a computationally expensive similarity score is generated for every original text in a seed database, the overall process of generating the similarity score can become lengthy. Thus it is contemplated that a computationally “cheap” similarity score be generated for a large number of original texts and a second computationally expensive similarity score be generated for good candidates.

In step 610 a first similarity score can be generated between an SUA and a large number of original texts in the seed database. The similarity score can be generated by a computationally cheap algorithm such as cosine similarity. The scored original texts can represent all original texts in the seed database. The scored original texts can represent a portion of the original texts in the database. The portion can be determined based on the subject matter of the DUA and the content of the SUA. For example, in a DUA that is a lease and an SUA that relates to attorneys fees, the portion of original texts of the seed database can be original texts that relate to attorneys fees in lease agreements. In this way, a first similarity score is not even generated for original texts that are unlikely to have similarity with the DUA

In step 620, a subset of the original texts for which a similarity score was generated in step 610 is chosen. The subset can be selected by thresholds and cutoffs. For example, a subset can include original texts that have a similarity score that exceed a threshold.

In another example, a subset can include the original texts having the “top 5” or “top 20” similarity scores.

In step 630, a second similarity score can be generated between the original texts in the subset and the SUA. The second similarity score can be a computationally expensive similarity score such as word-embedding model or syntactic structure oriented model that would require more time but would run on a subset of the original texts that appear to be related by cosine or another fast string matching score. In this way, the number of computationally expensive similarity scores to be calculated can be reduced.

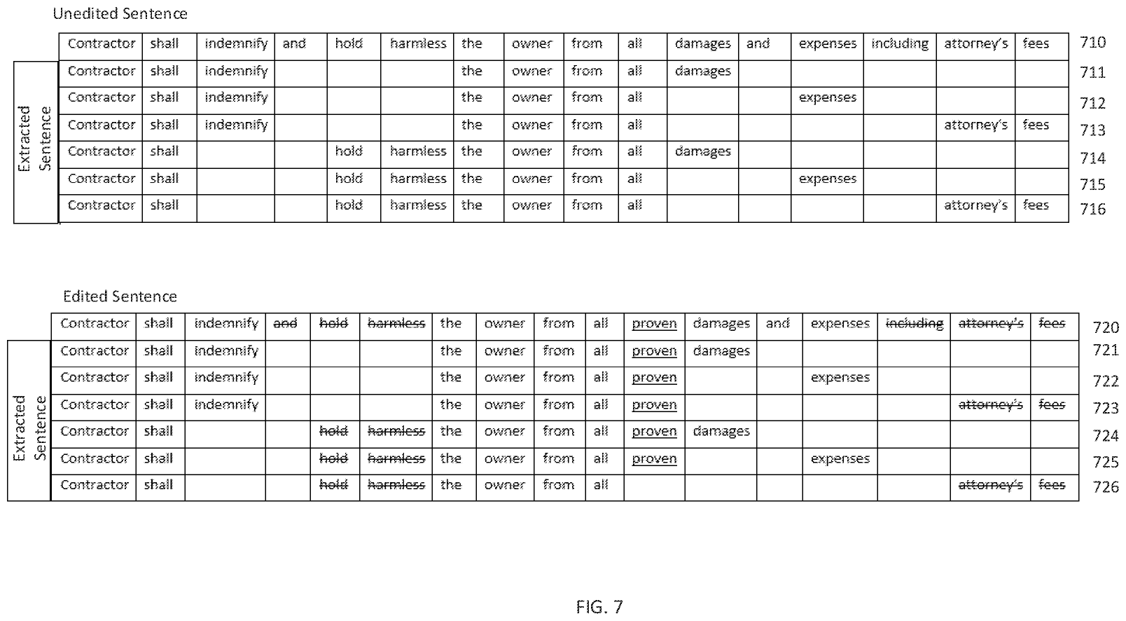

FIG. 7 is an illustration of multiple statement extraction according to embodiments disclosed herein. As shown in FIG. 7, an unedited compound sentence 710 can be “expanded” into many simplified unedited sentences 711-716. Each of the simplified unedited sentences 711-716 represents a logically truthful statement in view of the unedited compound sentence 710. Similarly, the edited compound sentence 720 can be “expanded” into many simplified edited sentences 721-726, each representing a logically truthful statement in view of the edited compound sentence 720. The expansion can be performed over conjunctions or lists of items.

In a more generalized example, the statement “you shall do A and B” is the logical concatenation of “you shall do A” and “you shall do B.” It follows then that if the statement is edited to “you shall do A′ and B” that the extracted statements “you shall do A′” and “you shall do B” are also true for the edited statement. In this simplified example there are at least two pieces of information having general applicability. First, that A has been edited to A′ and second, that B has remained B. In view of the foregoing, embodiments disclosed herein can suggest A be changed to A′ and B remain as B when reviewing other SUAs within the DUA or in other DUAs.

For the purposes of augmenting the seed database with more generalized original texts, an unedited compound statement such as 710 can be expanded to the simplified unedited sentences 711-716. These simplified unedited sentences 711-716 can be separately stored in the seed database together with their corresponding simplified edited sentences 721-726 expanded from the edited compound sentence 720.

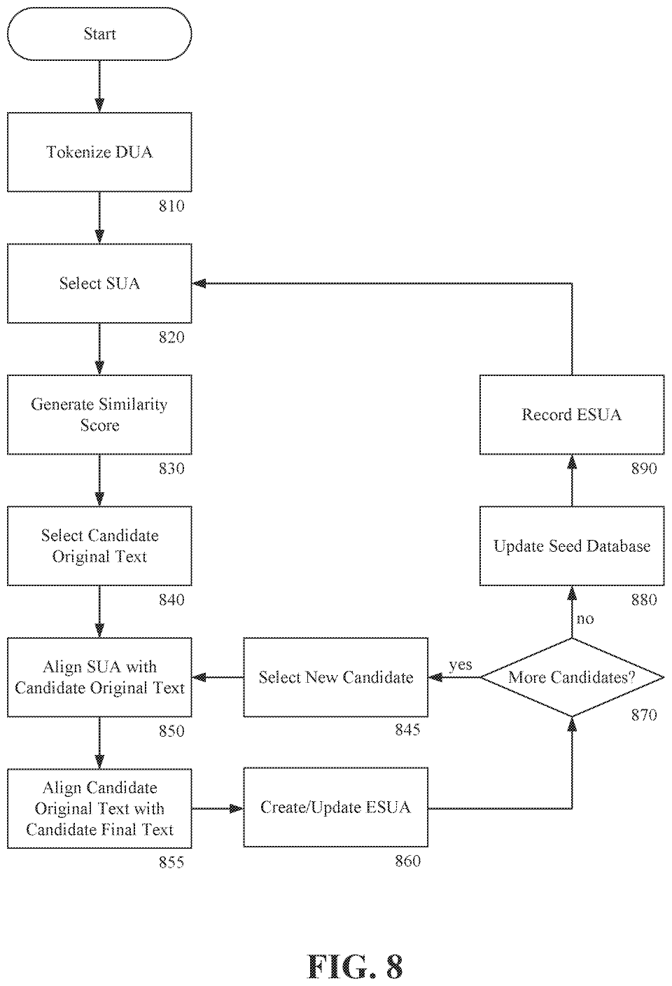

FIG. 8 is a process flowchart for editing a document and updating a seed database according to embodiments disclosed herein. As shown in FIG. 8, editing a document and updating a seed database can include tokenizing 810 a DUA (document under analysis), selecting 820 a SUA (statement under analysis), generating 830 similarity scores, selecting 340 a candidate original text, aligning 850 the SUA with the candidate original text, aligning 855 a candidate final text with the candidate original text, creating 860 an ESUA (edited statement under analysis), determining 870 whether there are additional candidates, selecting 845 a new candidate, updating 880 the seed database, and recording 8900 the ESUA.

In step 810, a DUA can be tokenized into a plurality of SUAs. The DUA can be tokenized in the same way as described in conjunction with FIG. 1 with tokenizing the original document and final document in creation of the seed database. The DUA can be selected by a user. The DUA can be an electronic document. The DUA can be proposed legal document such as lease, contract, or agreement. In the example of the apartment rental company, a DUA can be a proposed lease agreement provided by a prospective tenant. The DUA can be selected via a file-chooser dialog. The DUA can be selected via a context-menu. The DUA can be selected via a drop-down menu. The DUA can be selected via plug-in for a document management system or an e-mail program.

In step 820, an SUA can be selected. The SUA can be a first SUA of the DUA In subsequent iterations, successive SUAs can be selected such as the second SUA, the third SUA, and so on. Each SUA can be selected in succession.

In step 830, a similarity score can be generated. The similarity score can represent a degree of similarity between the currently selected SUA and at least some of the original texts in the seed database. The similarity score can be generated according to the process described in conjunction with FIG. 6.

In step 840, a candidate original text can be selected. The selected candidate original text can be the original text having the best similarity score. In embodiments where a single similarity score is calculated, the candidate original text can be selected from the original texts for which a similarity score was generated. In embodiments where two similarity scores are generated, such as described in conjunction with FIG. 6, the candidate original text can be selected from the original texts for which a second similarity score was generated.

A candidate original text can be selected from a filtered subset of the original texts. For example, a candidate original text can be selected from the “top 10” original texts based on a second similarity score. In another example, a candidate original text can be selected from the set of original texts having a second similarity score that exceeds a predetermined threshold. The selection can be the “best” similarity score. The selection can be the original text from a filter list having a longest matching substring in common with the SUA.

In step 850, the selected candidate original text can be aligned with the SUA.

In step 855, the candidate edited text can be aligned with the candidate original text.

In step 860, an ESUA (edited statement under analysis) can be created. The ESUA can be created by applying edits from a final text associated with the candidate original text to the SUA. The process of applying the edits is described in more particularity in conjunction with discussion of alignment in FIG. 3-FIG. 5.

The foregoing alignment and creating an ESUA (steps 850, 855, and 860) of the embodiment described in FIG. 8 can be described as a single alignment of an SUA, original text, and edited text. However, it should be appreciated that the steps 850, 855, and 860 could be repeated to achieve a second alignment and updating of the ESUA consistent with the example described in conjunction with FIG. 4.

In step 870, it can be determined if there are additional candidate original texts. In the example where a “top 10” original texts are filtered from the original texts for consideration in the selection step 840, the decision step 870 can evaluate whether there are additional original texts of the “top 10” to be considered. If there are additional candidates, the process can transition to select new candidate step 845. If no candidates remain, the process can transition to update seed database step 880.

The select new candidate step 845 can be consistent with the multiple statement alignment described in conjunction with FIG. 5. In the example where a “top 10” original texts were filtered for potential selection in step 840, an unselected one of the “top 10” can be selected in the select new candidate step 845. The new candidate original text and its corresponding edited text can be aligned with the SUA in steps 850 and 855. The ESUA can be updated with the edits from the new candidate in step 860.

Although not shown in FIG. 8, it should be appreciated that throughout the process of suggesting edits, various edits and suggestions can be presented to the user for confirmation and further editing prior to finalizing a document. For example, a user interface for a software application implementing the embodiments disclosed herein can provide a visual indication of all of the edits suggested to a DUA and its SUAs. A user can use such a user interface to further revise the ESUAs or edit unedited SUAs. A user can further select an unedited SUA and manually enter revisions. Revisions entered by a user can be stored in the seed database in step 880.

In update seed database step 880, the seed database can be updated by saving the SUAs and the corresponding ESUAs. In some cases the SUA will not have a corresponding ESUA indicating that the text was acceptable as proposed. In these cases, an ESUA can be generated that is identical to the SUA and both SUA and identical ESUA can be stored in the seed database. In this way, the seed database grows with each DUA and edits made to an SUA or SUAs accepted without revision will be retained in the institutional knowledge of the seed database. Although this step 880 is illustrated as occurring after the step 860 and before the step 820, it should be appreciated that the updating the seed database step 880 can occur at any time after an ESUA is created. In a preferred embodiment, the updating the seed database step 880 can occur after all SUAs of a DUA have been analyzed and a user has confirmed the edits are accurate and complete.

In step 890, the ESUAs can be recorded. In a first example, the ESUAs can be recorded at the end of the DUA in an appendix. The appendix can specify amendments and edits to the DUA In this way, and original words of the DUA are not directly edited, but an appendix specifies the revised terms. This first method of recording the ESUAs can be utilized with the DUA is a PDF document than cannot easily be edited. In a second example, the ESUA can be recorded in-line in the DUA Each ESUA can be used to replace the corresponding SUA In embodiments disclosed herein, the ESUA can be inserted in place of the SUA with “track changes” indicating the edits being made. This second method of recording the ESUAs can be utilized when the DUA is in an easily editable format such as Microsoft Word. In a third example, the ESUAs can be recorded in a separate document. The separate document can refer to the SUAs of the DUA and identify corresponding ESUAs. This third method can be utilized when the DUA is a locked or secured document that does not allow editing.

Again, although this step 890 is illustrated as occurring after the step 880 and before the step 820, it should be appreciated that the recording the ESUA step 890 can occur at any time after an ESUA is created. In a preferred embodiment, the recording the ESUA step 890 can occur after all SUAs of a DUA have been analyzed and a user has confirmed the edits are accurate and complete.

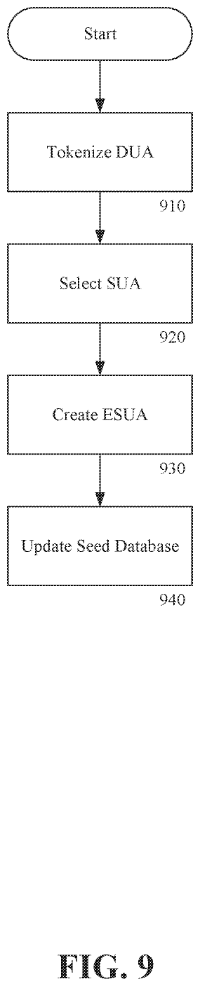

FIG. 9 is a process flowchart for editing a document and updating a seed database according to embodiments disclosed herein. As shown in FIG. 9, editing a document and updating a seed database can include tokenizing 910 a DUA, selecting 920 an SUA, creating 930 an ESUA, and updating 940 a seed database.

In step 910, a DUA can be tokenized in the same manner as described in conjunction with step 210 of FIG. 2.

In step 920, a SUA can be manually selected by a user. A user can select an SUA that the user desires to modify.

In step 930, a user can manually modify an SUA to create an ESUA. This process of selecting and editing can be consistent with a user revising a document according to their knowledge, expertise, or business objectives.

In step 940, the SUA and the ESUA can be stored in a seed database. If the SUA was not edited, the SUA can be copied to the ESUA and both can be stored in a seed database. The embodiment of FIG. 9 can be useful when a seed database does not exist. The embodiment of FIG. 9 can be useful when the seed database has insufficient content to suggest useful edits. In this way, the seed database can grow from normal document review and editing.

Embodiments disclosed herein can be implemented as a software application executable on a computer terminal or distributed as a series of instructions recorded on computer-readable medium such as a CD-ROM. The computer can have memory such as a disk for storage, a processor for performing calculations, a network interface for communications, a keyboard and mouse for input and selection, and a display for viewing. Portions of the embodiments disclosed herein, such as the seed database, can be implemented on a database server or stored locally on a user's computer. Embodiments disclosed herein can be implemented in a remote or cloud computing environment where a user can interface with the embodiments disclosed herein through a web browser. Embodiments disclosed herein can be implemented as plug-in for popular document editing software (e.g. Microsoft Word) that can suggest revisions to an SUA through the document editing software.

Generally speaking, an “edit operation” means that between the original text and the final text, some text was deleted, replaced, inserted. The concept of “type of edit” refers to the type of edit operation that was performed on the original text in the seed database to get to the final text in the seed database. Non-limiting examples of the “type of edit” can include, for example, a full sentence edit, a parenthetical edit, a single word edit, a structured list edit, an unstructured list edit, or a fronted constituent edit.

A type of edit can be a “full sentence delete” such as deleting the sentence: “In the event disclosing party brings suit to enforce the terms of this Agreement, the prevailing party is entitled to an award of its attorneys' fees and costs.”

A type of edit can be a “full sentence replace” such as replacing the sentence “Receipt of payment by the Contractor from the Owner for the Subcontract Work is a condition precedent to payment by the Contractor to the Subcontractor,” with “In no event and regardless of any paid-if-paid or pay-when-paid contained herein, will Contractor pay the Subcontractor more than 60 days after the Subcontractor completes the work and submits an acceptable payment application.”

A type of edit can be a “full sentence insert,” which can be performed after a particular sentence, or a sentence having a particular meaning, for example, taking an original sentence “In the event of Recipient's breach or threatened breach of this Agreement, Disclosing Party is entitled, in addition to all other remedies available under the law, to seek injunctive relief,” and inserting after the sentence: “In no event; however, will either Party have any liability for special or consequential damages.”

A type of edit can be a “full sentence insert,” which can be performed where an agreement is lacking required specificity, for example by adding “The Contractor shall provide the Subcontractor with the same monthly updates to the Progress Schedule that the Contractor provides to the Owner, including all electronic files used to produce the updates to the Progress Schedule.”

A type of edit can be a “structured list delete”, for example, deleting “(b) Contractor's failure to properly design the Project” from the following structured list: “Subcontractor shall indemnify Contractor against all damages caused by the following: (a) Subcontractor's breach of the terms of this Agreement, (b) Contractor's failure to properly design the Project, and (c) Subcontractor's lower-tier subcontractor's failure to properly perform their work.”

A type of edit can be a “structured list insert” such as the insertion of “(d) information that Recipient independently develops” into a structured list as follows: “Confidential Information shall not include (a) information that is in the public domain prior to disclosure, (b) information that Recipient currently possesses, (c) information that becomes available to Recipient through sources other than the Disclosing Party, and (d) information that Recipient independently develops.”

A type of edit can be a “leaf list insert” such as inserting “studies” into the following leaf list: “The ‘Confidential Information,’ includes, without limitation, computer programs, names and expertise of employees and consultants, know-how, formulas, studies, processes, ideas, embodiments disclosed hereins (whether patent-able or not) schematics and other technical, business, financial, customer and product development plans, forecasts, strategies and information.”

A type of edit can be a “leaf list delete” such as deleting “attorneys' fees” from the following leaf list: “Subcontractor shall indemnify Contractor against all damages, fines, expenses, attorneys' fees,-costs, and liabilities arising from Subcontractor's breach of this Agreement.”

A type of edit can be a “point delete” such as deleting “immediate” from the following sentence: “Recipient will provide immediate notice to Disclosing Party of all improper disclosers of Confidential Information.”

A type of edit can be a “span delete” such as deleting “consistent with the Project Schedule and in strict accordance with and reasonably inferable from the Subcontract Documents” from the following text: “The Contractor retains the Subcontractor as an independent contractor, to provide all labour, materials, tools, machinery, equipment and services necessary or incidental to complete the part of the work which the Contractor has contracted with the Owner to provide on the Project as set forth in Exhibit A to this Agreement, consistent with the Project Schedule and in strict accordance with and reasonably inferable from the Subcontract Documents.”

A type of edit can be a “point replace” such as replacing “execute” in the following text with “perform:” “The Subcontractor represents it is fully experienced and qualified to perform the Subcontract Work and it is properly equipped, organized, financed and, if necessary, licensed and/or certified to execute the Subcontract Work.”

A type of edit can be a “point insert” such as inserting “reasonably” as follows: “The Subcontractor shall use properly-qualified individuals or entities to carry out the Subcontract Work in a safe and reasonable manner so as to reasonably protect persons and property at the site and adjacent to the site from injury, loss or damage.”

A type of edit can be a “fronted constituent edit” such the insertion of “Prior to execution of the Contract” in the following text: “Prior to execution of the Contract, Contractor shall provide Subcontractor with a copy of the Project Schedule.”

A type of edit can be an “end of sentence clause insert” such as the insertion of “except as set forth specifically herein as taking precedent over the Contractor's Contract with the Owner” as follows: “In the event of a conflict between this Agreement and the Contractor's Contract with the Owner, the Contractor's Contract with the Owner shall govern, except as set forth specifically herein as taking precedent over the Contractor's Contract with the Owner.”

A type of edit can be a “parenthetical delete” such as deleting the parenthetical “(as evidenced by its written records)” in the following text: “The term ‘Confidential Information’ and the restrictions set forth in Clause 2 and Clause 5 of this Schedule ‘B’ shall not apply to information which was known by Recipient (as evidenced by its written records) prior to disclosure hereunder, and is not subject to a confidentiality obligation or other legal, contractual or fiduciary obligation to Company or any of its Affiliates.”

A type of edit can be a “parenthetical insert” such as the insertion of “(at Contractor's sole expense” in the following text: “The Contractor shall (at Contractor's sole expense) provide the Subcontractor with copies of the Subcontract Documents, prior to the execution of the Subcontract Agreement.”

Although many types of edits have been disclosed and described, the embodiments disclosed herein are not limited to the specific examples of types of edits provided and those of skill in the art will appreciate that other types of edits are possible and therefore fall within the embodiments described herein.

The following accompanying additional drawings, which are included to provide a further understanding of embodiments disclosed herein and are incorporated in and constitute a part of this specification, illustrate embodiments and together with the description serve to explain the principles of embodiments disclosed herein.

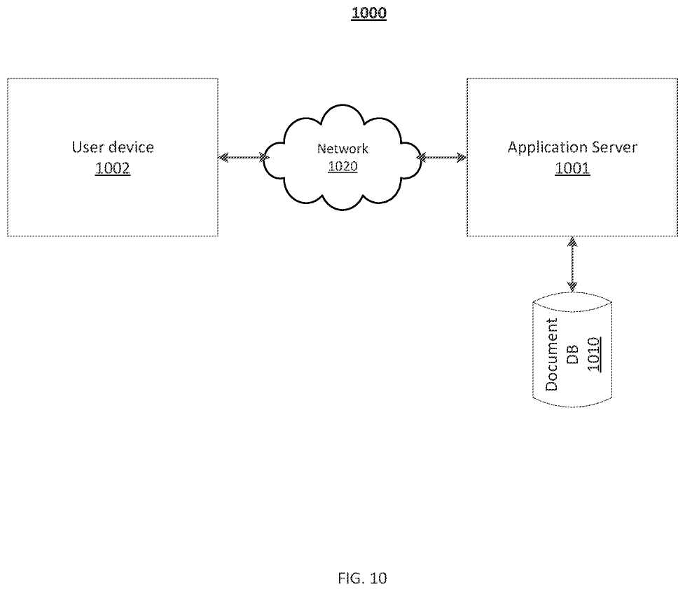

FIG. 10 is a block diagram illustrating a system for suggesting revisions to an electronic document 1000, according to some embodiments. A user device 1002, such as a computer, mobile device, tablet, and the like, may be in communication with one or more application servers 1001. In some embodiments, the user device 1002 is in communication with application server 1001 via a network 1020. In some embodiments, network 1020 may be a local area network or a wide area network (e.g., the Internet).

In some embodiments, the system 1000 may further include one or more data sources, such a document database 1010 (sometimes referred to herein as a “seed database”). The document database 1010 may be configured to store one or more documents, such as, for example, a DUA. In some embodiments, the document database 1010 may be referred to as a “seed database.” As described above, the seed database of past edits may comprise “original text” and “final text” representing, respectively, an unedited text and the corresponding edit thereto.

In some embodiments, the user device 1002, document database 1010, and/or application server 1001 may be co-located in the same environment or computer network, or in the same device.

In some embodiments, input to application server 1001 from client device 1002 may be provided through a web interface or an application programming interface (API), and the output from the application server 1001 may also be served through the web interface or API.

While application server 1001 is illustrated in FIG. 10 as a single computer for ease of display, it should be appreciated that the application server 1001 may be distributed across multiple computer systems. For example, application server 1001 may comprise a network of remote servers and/or data sources hosted on network 1020 (e.g., the Internet) that are programmed to perform the processes described herein. Such a network of servers may be referred to as the backend of the clause library system 1000.

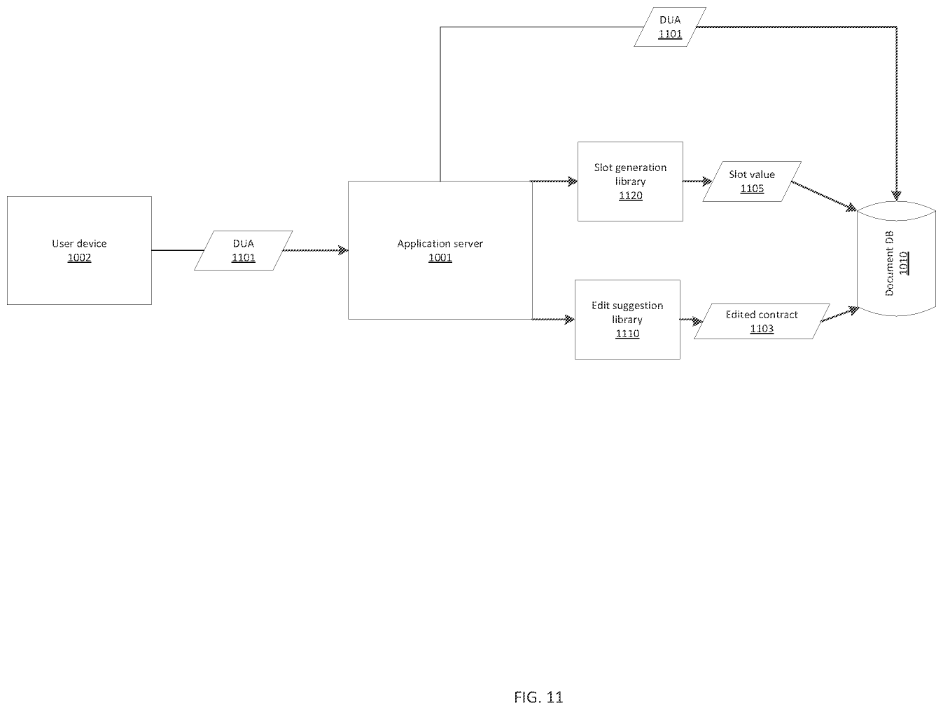

FIG. 11 is a data flow diagram of a document upload process with edit suggestion, according to some embodiments. As shown in FIG. 11, a user may upload a previously unseen document, or document under analysis (DUA), 1101 to application server 1001 using a web interface displayed on user device 1002. In some embodiments, the application server 1001 stores the received DUA 1101 in document database 1010.

According to some embodiments, the application server 1001 may comprise one or more software modules, including edit suggestion library 1110 and slot generation library 1120.

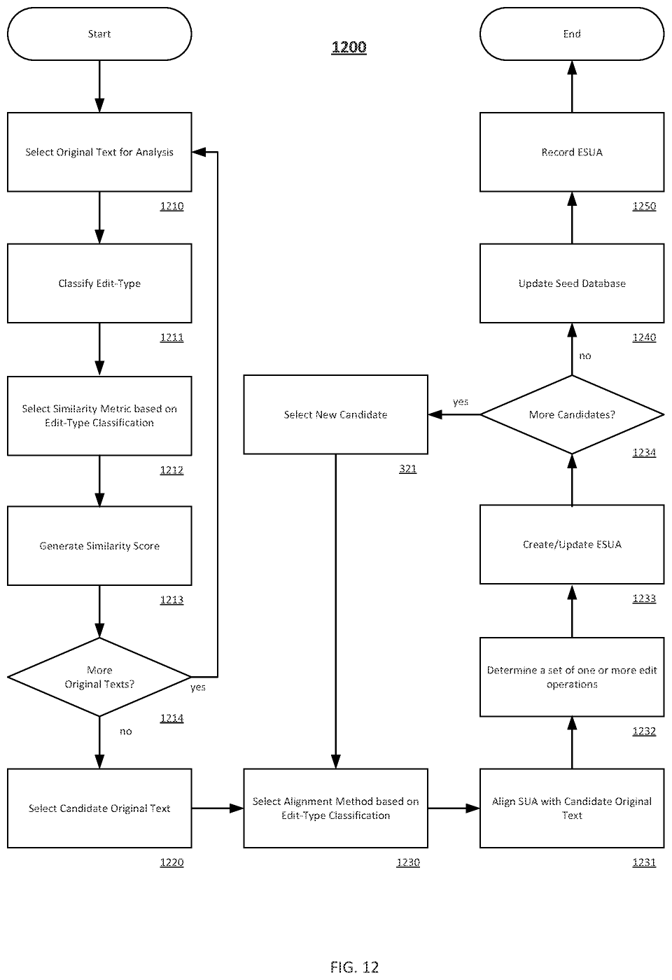

Edit suggestion library 1110 may comprise programming instructions stored in a non-transitory computer readable memory configured to cause a processor to suggest edits to the DUA 1101. The edit suggestion library 1110 may perform alignment, edit suggestion, and edit transfer procedures to, inter alia, determine which sentences in a document should be accepted, rejected, or edit, and transfers edits into the document. The application server 1001 may store the resulting edited document or set of one or more edits in association with the DUA 1101 in document database 1010. The edit suggestion features are described more fully in connection with FIGS. 12-16 and 18, described below.

In embodiments where the application server comprises a slot generation library 1120, a user may upload a Typical Clause to application server 1001 using a web interface displayed on user device 1002. In some embodiments, the application server 1001 stores the received Typical Clause in a clause library database (not shown in FIG. 11). In some embodiments, slot generation library 1120 may comprise programming instructions stored in a non-transitory computer readable memory configured to cause a processor to implement slot generation features as described more fully in U.S. application Ser. No. 16/197,769, filed on Nov. 21, 2018, which is a continuation of U.S. application Ser. No. 16/170,628, filed on Oct. 25, 2018, the contents of which are incorporated herein by reference. As a result of these processes, the slot generation library 1120 may output a set of one or more slot values corresponding to the received DUA. The application server 1001 may store such slot values in association with the DUA 1101 in document database 110.

In some embodiments, the slot generation library 1120 and the edit suggestion library 1110 may be used in combination. For example, the edit suggestion library 1110 may benefit when used in conjunction with a slot normalization process utilizing slot generation library 1120 where the surface form of slot types are replaced with generic terms. During alignment, unseen sentence may be aligned with an optimal set of training sentences for which the appropriate edit operation is known (e.g., accept, reject, edit). However, during alignment, small differences in sentences can tip the similarity algorithms one way or the other. By introducing slot normalization to the training data when it is persisted to the training database, and again to each sentence under analysis, the likelihood of alignment may be increased when terms differ lexically but not semantically (for instance “Information” vs “Confidential Information”). If an edit is required, the edit transfer process may use the normalized slots again to improve sub-sentence alignment. The edit transfer process may search for equal spans between the training sentence and the SUA in order to determine where edits can be made. Slot normalization may increase the length of these spans, thereby improving the edit transfer process. Additionally, suggested edits may be inserted into the DUA 1101 with the proper slot value.

The edit suggestion system 1000 may comprise some or all of modules 1110, 1120 as depicted in FIG. 11.

FIG. 12 is a process flow chart for editing a SUA and updating a seed database according to some embodiments. In some embodiments, process 1200 may be performed by edit suggestion system 1000 and/or application server 1001. As shown in FIG. 12, editing an SUA may comprise selecting an original text from the seed database for analysis 1210, classifying an edit-type between the selected original text and the corresponding final text 1211, selecting a similarity metric based on the edit-type classification 1212, and generating a similarity score 1213 between the original text and the SUA. In decision step 1214, the process determines whether additional original texts exist for which a similarity score should be calculated. If “yes”, the process transitions back to step 1210 where a new original text is selected for analysis. If “no” the process transitions to step 1220.

The process of editing an SUA may further comprise selecting a candidate original text 1220, selecting an alignment method based on the edit-type classification 1230, aligning the SUA with the candidate original text according to the selected alignment method 1231, determining a set of one or more edit operations according to the selected alignment method 1232, and creating or updating the ESUA 1233. In decision step 1234, the process determines whether there are additional candidate original texts and, if so, a new candidate is selected 1221 and the process transitions back to step 1230, selecting an alignment method based on edit-type classification. If there are no more candidates in step 1234, the process transitions to step 1240 where the seed database is updated with the SUA and new ESUA. Finally, the ESUA can be substituted into the DUA in place of the SUA, or the edits may be applied directly to the DUA, in step 1250.

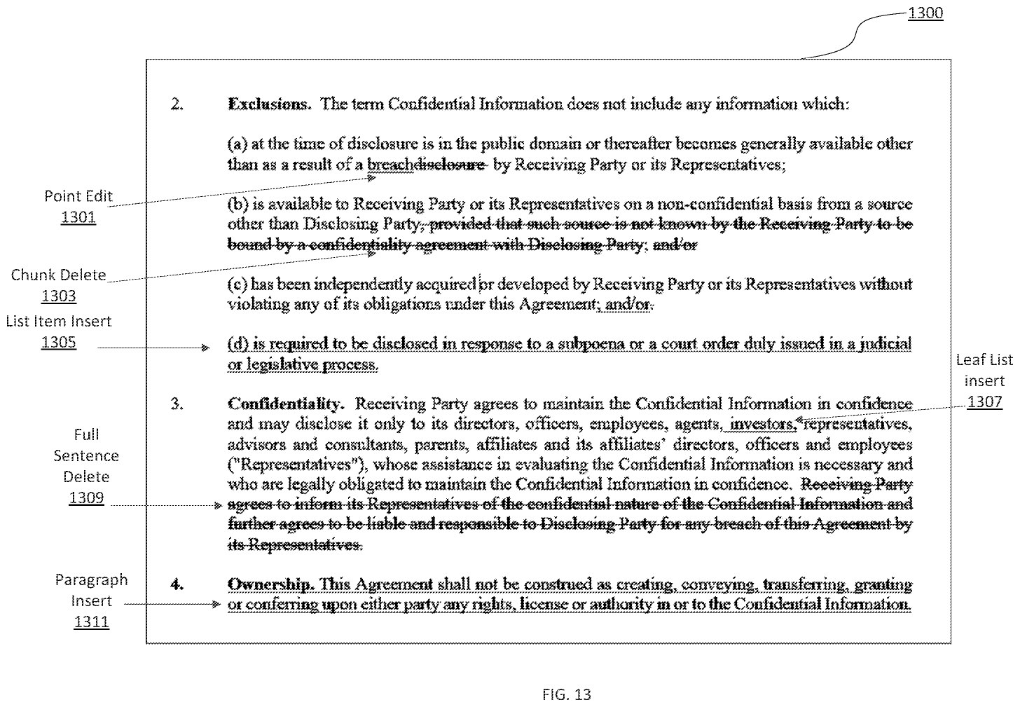

In greater detail, in step 1210, a first original text can be selected from the seed database for comparison against a SUA. In step 1211, the selected original text and its corresponding final text can be classified according to the type of edit that was applied to the original text. The classification of step 1211 can occur in real time when an original text is selected for analysis. In the alternative, the classification of step 1211 can occur as part of the creation of the seed database. In some embodiments, the classification step 1211 may further include classifying a potential edit type based on the text of the SUA in the case of, for example, a leaf list and structured list edit. An example classification procedure is described in further detail below and in connection with FIG. 13.

In step 1212, a similarity metric can be selected based on the type of edit. For example, the cosine distance algorithm can provide a good measure of similarity between an original text and an SUA for a single word insert. Thus, for entries in the seed database of a single word insert the process can advantageously select the cosine distance algorithm to determine the degree of similarity between the SUA and the original text. In another example, edit distance can provide a good measure of similarity between an original text and an SUA for a full sentence delete. Thus, for entries in the seed database of a full sentence delete, the process can advantageously select edit distance to determine the degree of similarity between the SUA and the original text.

In step 1213, a similarity score for the selected original text and the SUA is calculated based on the selected similarity metric for that edit type. In step 1214, the process determines if there are additional original texts to be analyzed for similarity. In the example of a seed database there are typically many original texts to analyze and the process loops back to step 1210 until all the original texts have been analyzed and a similarity score generated.

In some embodiments, a text under analysis (TUA) may be used for alignment, which comprises a window of text from the DUA, which may span multiple sentences or paragraphs, where a full edit operation may be performed. Full edit types may rely on a similarity metric calculated over a window of text before and/or after the original text and a set of such windows from the DUA. The window from the DUA with the highest score as compared to the original text's window becomes the text under analysis (TUA) into which the full edit operation is performed, producing the full edit, which may be the deletion of all or part of the TUA or the insertion of the final text associated with the original text. In some embodiments, a window of text is extracted from the original texts' document context. That window is then used to search the DUA for a similar span of text. The original text with the highest similarity value, according to one or more similarity metrics (such as cosine distance over TF/IDF, word count, and/or word embeddings for those pairs of texts), on the window of text may be selected.

In some embodiments, once a span edit, such as the deletion of a parenthetical or other short string longer than a single word, is detected, the best original text from among the set of aligned original texts may be selected. A Word Mover Distance similarity metric may be used to compare the deleted span with spans in the TUA and the original text with the nearest match to a span in the TUA is selected. This allows semantically similar but different spans to be aligned for editing. In some embodiments, span edits may rely on a Word Embedding based similarity metric to align semantically related text spans for editing. The relevant span of the original text is compared to spans of the TUA such that semantically similar spans are aligned where the edit operation could be performed.

In step 1220, a candidate original text can be selected. The candidate can be selected based on the similarity score calculated in step 1213. There can be multiple candidate original texts. For example, in step 1220, the original text having the highest similarity score, or an original text exceeding some threshold similarity score, or one of the original texts having the top three similarity scores may be selected. Selecting a candidate original text in this step 1220 may consider other factors in addition to the similarity score such as attributes of the statement under analysis. In any event, each original text that meets the selection criteria can be considered a candidate original text.

In step 1230, an alignment method can be selected based on the edit-type classification for the selected candidate original text. Improved alignment between the SUA, original text, and final text can be achieved when the alignment method is selected based on the edit-type classification rather than employing a single alignment method for all alignments. For example, a longest-matching substring can provide a good alignment between an original text and an SUA for a single word insert. Thus, for entries in the seed database of a single word insert, the process can advantageously select longest matching substring to align the SUA and the original text. In another example, a constituent-subtree alignment can provide a good alignment between an original text and an SUA for a structured-list insert. Thus, for entries in the seed database of structured-list insert the process can advantageously select a constituent-subtree alignment to align the SUA and the original text. Additional alignment methods are described in further detail below.

In step 1231 the SUA and the candidate original text are aligned according to the alignment method selected in step 1230. In step 1232, a set of one or more edit operations is determined according to the alignment method selected in step 1230. In some embodiments, the set of one or more edit operations may be determined by aligning the candidate original text with its associated final text according to the alignment method selected in step 1230, and determining a set of one or more edit operations that convert the aligned original text to the aligned final text. In such embodiments, in step 1233 the SUA is created by applying the set of one or more edit operations.

In some embodiments, in step 1232, the set of one or more edit operations may be determined by determining a set of edit operations that convert the SUA to the final text associated with the original text. In such embodiments, in step 1233 the SUA is created by applying to the SUA one or more edit operations from the set of one or more edit operations according to the alignment method.

Step 1234 can be consistent with multiple alignment, that is, where a SUA is aligned and is edited in accordance with multiple original/final texts from the seed database. In step 1234, it can be determined whether there are additional candidate original texts that meet the selection criteria (e.g. exceed a similarity score threshold, top three, etc). If “yes” the process proceeds to step 1221 where a new candidate original text is selected. If no, the process can proceed to step 1240.

In step 1240, the seed database can be updated with the SUA and the ESUA which, after adding to the seed database would be considered an “original text” and a “final text,” respectively. In this way, the methods disclosed herein can learn from new DUAs and new SUAs by adding to its seed database.

In some embodiments, there may also be a step between 1234 and 1240 where a human user reviews the proposed ESUA of the EDUA to (a) accept/reject/revise the proposed revisions or (b) include additional revisions. This feedback may be used to improve the similarity score metrics (e.g., by training the system to identify similar or dissimilar candidate original texts) and/or the suggested edit revision process (e.g., by training the system to accept or reject certain candidate alignments) for specific user(s) of the system 100.

In step 1250 the ESUA can be recorded back into the DUA in place of the SUA, or the edit can be applied to the text of the DUA directly.

### Training Data Creation

It is contemplated that potential users of the embodiments disclosed herein may not have a large database of previously edited documents from which to generate the seed database. To address this limitation, embodiments disclosed herein include generating a seed database from documents provided by a third party or from answering a questionnaire. For example, if a user is a property management company that does not have a sufficient base of previously edited documents from which to generate a seed database, embodiments may include sample documents associated with other property management companies or publicly available documents (e.g. from EDGAR) that can be used to populate the seed database.

In another example, if a user does not have a sufficient base of previously edited documents from which to generate a seed database, embodiments may ask legal questions to the user to determine a user's tolerance for certain contractual provisions. In greater detail, during a setup of the embodiments disclosed herein, the user may be asked, among other things, whether they will agree to “fee shifting” provisions where costs and attorneys' fees are borne by the non-prevailing party. If yes, the embodiments disclosed herein can populate the seed database with original/final texts consistent with “fee shifting,” e.g., the original and final texts contain the same fee shifting language. If not, the embodiments disclosed herein can populate the seed database with original/final texts consistent with no “fee shifting,” e.g., the original text contains fee shifting language and the final text does not contain fee shifting language.

FIG. 13 illustrates an edited document, according to some embodiments. As shown in FIG. 13, edited document 1300 may comprise an Open Document Format (ODT) or Office Open XML (OOXML) type document with tags representing portions of the original document that have been revised by an editor. In some embodiments, the tags may comprise “Track-Changes” tags as used by certain document editing platforms.

As shown FIG. 13, edited document 1300 may comprise a plurality of classified edits, such as a point edit (1301); a chunk delete (1303); a list item insert (1305); a leaf list insert (1307); a full sentence delete (1309); and a paragraph insert (1311). Additional edits not shown in edited document 1300 may comprise, e.g., a span edit and a full sentence insert.

Edit Suggestion System 1000 may ingest a document 1300 by traversing its runs in order. In some embodiments, a “run” may refer to the run element defined in the Open XML File Format. Every run may be ingested and added to a string representing the document in both its old (original) and new (edited/final) states. The system 1000 may note, for each subsequence reflecting each run, whether each subsequence appears in the old and new states. A subsequence may comprise, for example, an entire document, paragraphs, lists, paragraph headers, list markers, sentences, sub-sentence chunks and the like. This list is non-exhaustive, and a person of ordinary skill in the art may recognize that additional sequences of text, or structural elements of text documents, may be important to capture.

A set of strings may be assembled from each subsequence, where one string in the set reflects an old state (e.g., original text) and a second string in the set reflects a new state (e.g., final or edited text). In some embodiments, each string is processed to identify linguistic features, such as word boundaries, parts of speech, list markets, list items, paragraph/clause headers, and sentence/chunk boundaries. In some embodiments, the system requires identification of sentence boundaries for alignments. However, the system may determine these linguistic features statistically; as a result, small changes in the data can result in big changes in the boundaries output. Therefore, it may be necessary to create a merger of all sentences where, given overlapping but mismatched spans of text, spans representing the largest sequences of overlap are retained.

Once this merger of all sentences has been determined, the set of merged sentences may be used to identify whether one or more edit types have occurred. Such edit types may include, for example, a full edit (e.g., sentence or paragraph), list edit (structured or leaf list), chunk edit, point edit, or span edit, among others.

In some embodiments, in order to identify full paragraph edits, the system first determines, for strings corresponding to a paragraph in document 1300, whether there are characters in both the old and new states. If the old state has no characters and the new state does, that is a full paragraph insert (FPI); if the new state has no characters and the old state does, that is a full paragraph delete (FPD).

In some embodiments, in order to identify full sentence edits, for each sentence or special sentence in a paragraph, the system attempts to pair each sentence in each state (e.g., original) with a sentence in the other state (e.g., final). If the pairing succeeds, then no full change occurred. If the pairing fails for a sentence in the old state (e.g., original), the sentence is tagged as a full sentence delete (FSD); if the pairing fails for a sentence in the new state (e.g., final), the sentence is tagged as a full sentence insert (FSI).

In some embodiments, in order to identify full chunk edits, for each sentence or special sentence in a paragraph, the system attempts to pair each constituent in each state (e.g., original) with a chunk in the other state (e.g., final). If the pairing succeeds, then no full change occurred. If the pairing fails for a chunk in the old state (e.g., original), the chunk is tagged as a full chunk delete (FCD); if the pairing fails for a chunk in the new state (e.g., final), the chunk is tagged as a full chunk insert (FCI).

In some embodiments, in order to identify structured list edits, the system attempts to pair list items in a structured list in each state (e.g., original) with a list item in the other state (e.g., final). If the pairing succeeds, then no structured list edit occurred. If the pairing fails for a list item in the old state (e.g., original), the list item is tagged as an List Item Delete; if the pairing fails for a list item in the new state (e.g., final), the list item is tagged as a List Item Insert.

In some embodiments, if the new state (e.g., original) and the old state (e.g., final) are equal, then the string of text is labeled as an “accept.”

In some embodiments, if the new state and the old state are not equal, but the change is not a “Full Edit” (e.g., FPD, FPI, FSD, or FSI), the string of text is labeled as a “revise.” Revises may be labeled as either “Point Edits” or “Span Edits.” Point Edits are insertions, single word replaces, and single word deletes. Span Edits are multi word deletes and multi word replaces. In some embodiments, a revise may be labelled as a “Full Edit” (e.g., FPD, FPI, FSD, or FSI).

In some embodiments, unstructured, syntactically coordinated natural language lists are identified with a regular pattern of part-of-speech tags, sentence classifications, and other features that are indicative of a list, manually tuned to fit such sequences.

For example, one embodiment of such a pattern may be: D?N+((N+),) *CN+; where D represents a token tagged as a determiner, N represents a token tagged as a noun, C represents a token tagged as a conjunction, and “,” represents comma tokens. Sequences that would match such a pattern include, for example: (i) any investor, broker, or agent; (ii) investor, broker, or agent; (iii) investor, stock broker, or agent; and (iv) all brokers or agents.

In some embodiments, additional information may be captured as part of the training process. For example, text classification (e.g., fee shifting; indemnification; disclosure required by law) may assist with augmenting the training data. The additional information may assist with creating a seed database through a question and answer system. Another example may include identifying choice of law SUA(s), and then identifying the jurisdictions or states within those provision (e.g., New York, Delaware), which may help with a question and answer learning rule such as always change the choice of law to New York. Another example may include classifying “term” clauses and durations in such clauses in order to learn rules about preferred durations.

### Point Edit Type Alignment

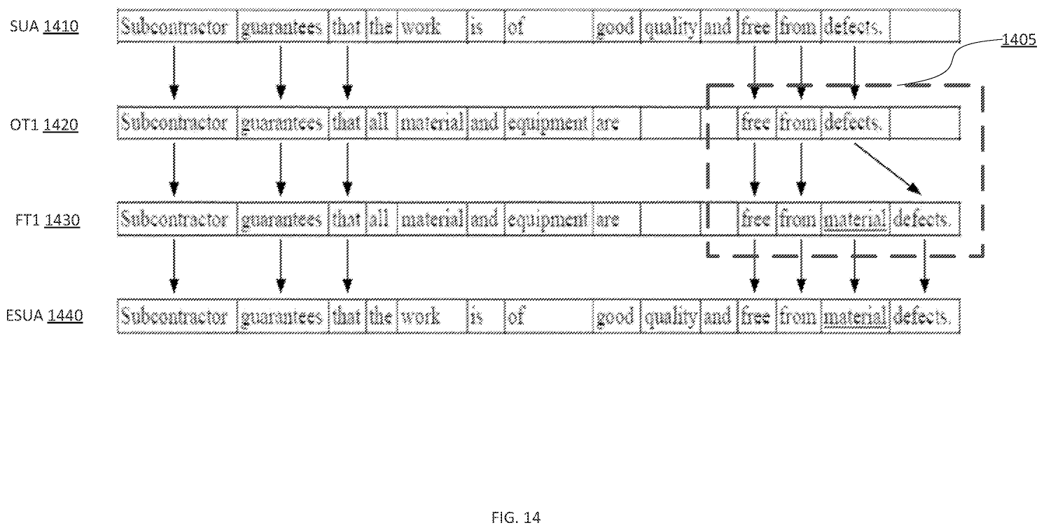

FIG. 14 is an illustration of a point edit-type alignment according to some embodiments. As shown in FIG. 14, the statement under analysis (SUA 1410) is matched with a candidate original text (OT1 1420) based on a similarity score as described above. As highlighted in box 1405, there is a point edit type between the original text (OT1 1420) and the final text (FT1 1430) because of the insertion of the word “material” into the final text (FT1 1430). Accordingly, an alignment method applicable for a point edit may be selected as shown in FIG. 14.

In some embodiments, the selected alignment may comprise aligning the SUA 1410 to the original text “OT1” 1420, aligning a corresponding final text “FT1” 1430 to the original text 1420, determining one or more edit operations to transform the original text “OT1” 1420 into the final text “FT1” 1430 according to the alignment (e.g., insertion of the word “material”), and creating the ESUA 1440 by applying the one or more edit operations to the statement under analysis “SUA” 1420.

In other embodiments, the selected alignment may comprise aligning the SUA 1410 to the original text “OT1” 1420, obtaining a corresponding final text “FT1” 1430, determining a set of one or more edit operations to transform the SUA 1410 into the FT1 1430, and applying to the SUA 1410 the one or more edit operations consistent with the first alignment (e.g., insertion of the word “material”).

These alignment techniques are disclosed more fully in U.S. application Ser. No. 15/227,093 filed Aug. 3, 2016, which issued as U.S. Pat. No. 10,216,715, and U.S. application Ser. No. 16/197,769, filed on Nov. 21, 2018, which is a continuation of U.S. application Ser. No. 16/170,628, filed on Oct. 25, 2018, which are hereby incorporated by reference in their entirety.

### Semantic Alignment

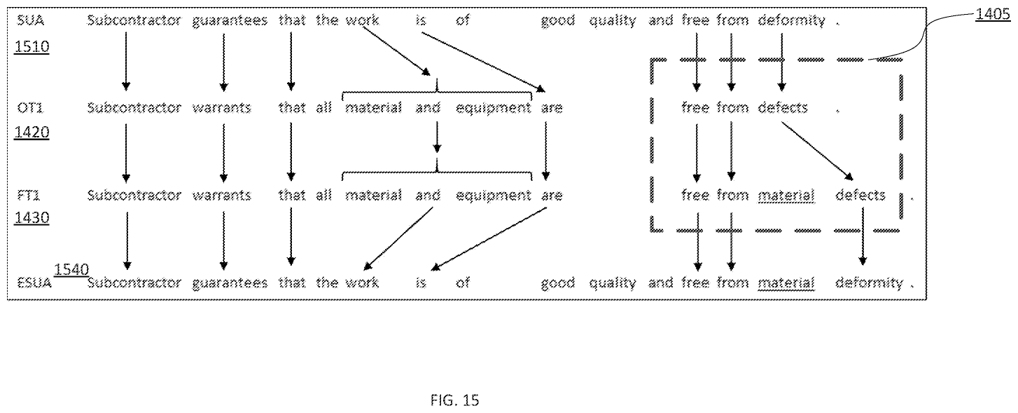

FIG. 15 is an illustration of a point edit-type alignment according to some embodiments. In some embodiments, the alignment procedures described above in connection with FIG. 14 and elsewhere herein do not require exact overlaps. For example, FIG. 15 illustrates SUA 1510, which is nearly identical to SUA 1410 in FIG. 5 except for the substitution of the word “defect” for “deformity.”

According to some embodiments, the training data is augmented to generate additional instances of sentences that are changed to use, e.g., paraphrases of words and phrases in the training sentence. Additional features of the training sentences may be extracted from document context and used to enhance alignment and support different edit types. Example features may include word embeddings for sentence tokens, user, counterparty, edit type, and edit context (e.g., nearby words/phrases). Augmentation of the training data in this manner may allow the system to perform semantic subsentence alignment, e.g., by enabling sub-sentence similarity tests to consider semantic similarity based on word embeddings.

Semantic subsentence alignment may enable the point edit type alignment procedure as disclosed above in connection with FIG. 14 to work when exact overlaps are not available—for example, ‘defects’ vs ‘deformity’ as shown in FIG. 15. Referring to FIG. 15, the statement under analysis (SUA 1510) may be matched with the same candidate original text (OT1 1420) based on a similarity score as described above. As highlighted in box 1405, there is a point edit type between the original text (OT1 1420) and the final text (FT1 1430) because of the insertion of the word “material” into the final text (FT1 1430). In view of the point edit type 1405, the system may proceed with performing the point edit type alignment procedure described above in connection with FIG. 14 in addition to semantic subsentence alignment. For example, using semantic subsentence alignment, the system is able to align “deformity” recited in SUA 1510 with “defects” recited in OT1 1420, as indicated by the arrows, and recognize the point edit operation of inserting the term “material” into the ESUA 1540.

### Span Edit Type Alignment

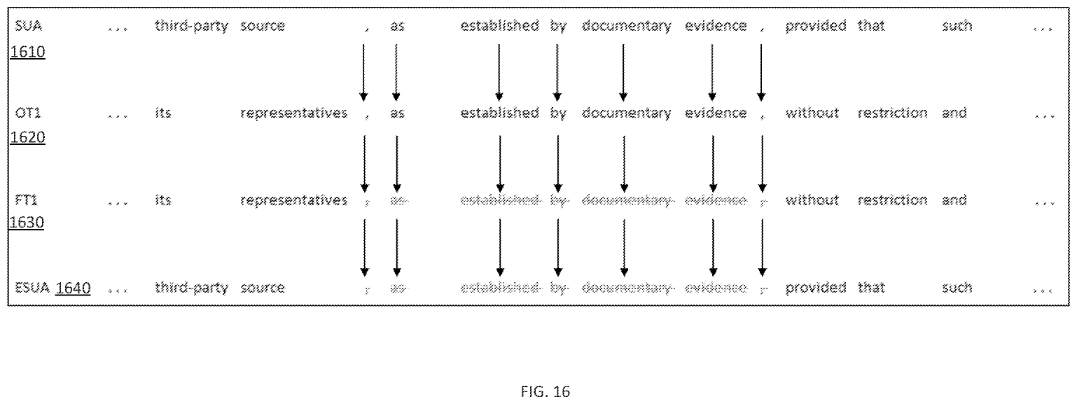

In some embodiments, span delete edit types might not require an alignment of the text the surrounds the deleted text. For example, Table A below depicts an example where a SUA has a high similarity score with a four different original texts because of the inclusion of the clause “as established by documentary evidence.” Each original text has a “SPAN” edit type operation as reflected by the deletion of the “as established by documentary evidence” between each Original Text and its respective Final Text. In this example, and as shown in FIG. 16, an alignment of the text surrounding the deleted phrase is unnecessary.

TABLE A

| SUA | Original Text | Final Text | Edit Op. | ESUA |
|---|---|---|---|---|
| (b) . . . available | (b) Such | (b) Such Proprietary | SPAN | (b) . . . available to |
| to the Recipient | Proprietary | Information is | | the Recipient on a |
| on a non- | Information is | already in the | | non-confidential |
| confidential | already in the | possession of the | | basis from a third- |
| basis from a | possession of | Receiving Party or | | party source |
| third-party | the Receiving | its representatives | | provided that such |
| source, as | Party or its | without restrict and | | third party is not . . . |
| established by | representatives, | prior to any | | |
| documentary | as established | disclosure hereunder | | |
| evidence, | by | | | |
| provided that | documentary | | | |
| such third party | evidence, | | | |
| is not . . . | without restrict | | | |
| | and prior to any | | | |
| | disclosure | | | |
| | hereunder | | | |
| (b) . . . available | d. is, as established | d. is-independently | SPAN | (b) . . . available to |
| to the Recipient | by documentary | developed by the | | the Recipient on a |
| on a non- | evidence, | Receiving Party. | | non-confidential |
| confidential | independently | | | basis from a third- |
| basis from a | developed by the | | | party source |
| third-party | Receiving Party. | | | provided that such |
| source, as | | | | third party is not . . . |
| established by | | | | |
| documentary | | | | |
| evidence, | | | | |
| provided that | | | | |
| such third party | | | | |
| is not . . . | | | | |
| (b) . . . available | (iii) was already in | (iii) was already in | SPAN | (b) . . . available to |
| to the Recipient | the possession of | the possession of the | | the Recipient on a |
| on a non- | the Recipient or its | Recipient or its | | non-confidential |
| confidential | Representatives, as | Representatives-on a | | basis from a third- |
| basis from a | established by | non-confidential | | party source |
| third-party | documentary | basis from a source | | provided that such |
| source, as | evidence, on a non- | other than the | | third party is not . . . |
| established by | confidential basis | Disclosing Parties | | |
| documentary | from a source other | prior to the date | | |
| evidence, | than the Disclosing | hereof | | |
| provided that | Parties prior to the | | | |
| such third party | date hereof | | | |
| is not . . . | | | | |
| (b) . . . available | (c) was lawfully | (c) was lawfully | SPAN | (b) . . . available |
| to the Recipient | acquired by the | acquired by the | | to the Recipient |
| on a non- | Recipient from a | Recipient from a | | on a non- |
| confidential | third party, as | third party-and not | | confidential |
| basis from a | established by | subject to any | | basis from a |
| third-party | documentary | obligation of | | third-party |
| source, as | evidence, and not | confidence to the | | source-provided |
| established by | subject to any | party furnishing the | | that such third |
| documentary | obligation of | Confidential | | party is not . . . |
| evidence, | confidence to the | Information. | | |
| provided that | party furnishing the | | | |
| such third party | Confidential | | | |
| is not . . . | Information. | | | |

FIG. 16 is an illustration of a span edit-type alignment according to some embodiments. As shown by the arrows in FIG. 16, an alignment of the text surrounding the deleted phrase “as established by documentary evidence” is not necessary. Namely, where the SUA (1610) and an OT1 (1620) are above a certain similarity threshold, and the SUA (1610) contains the same text as the OT1 (1620) that was deleted (or replaced) to arrive at the FT1 (1630), the same text present in the SUA (1610) may be deleted to arrive at the ESUA (1640). For example, as shown in FIG. 16, since there is the same text “, as established by documentary evidence,” in SUA (1610) and OT1 (1620), and there is a span delete edit type between OT1 (1620) and FT1 (1630) for that same text, then the system arrives at the ESUA (1640) by deleting the same text from SUA (1610).

In some embodiments, the training data augmentation process described above may also be used to enhance alignment and support span edits. For example, semantic subsentence alignment may enable the span edit type alignment procedure as disclosed above in connection with FIG. 16 to work when exact overlaps are not available.

According to some embodiments, span edits may rely heavily on two factors: (1) sentence or paragraph context, and (2) edit frequency. As part of the alignment process, the system may first extract candidate original text matches against a SUA as described above, and the candidate original text may indicate that a span edit is required based on the associated final candidate text. Next, the system may cluster span edits across all available training data (e.g., original and final texts) to find a best match for the SUA's context.

In some embodiments, the system may choose from the cluster the best span edit to make in this context. The selection may be based on some combination of context (words nearby) and frequency of the edit itself (e.g. how often has the user deleted a parenthetical that has high similarity to the one in the selected original text, within this context and/or across contexts). In some embodiments, if the selection is not the same as the best matching (similar) original text, the system may replace that selection with an original text with a higher similarity score.

Once the candidate original text is selected, the system may apply the edit using the alignment procedures described herein. An example of the semantic alignment as applied for a span delete is shown below in Table B.

TABLE B

| SUA | Original Text | Final Text | Edit Op. | ESUA |
|---|---|---|---|---|
| (b) . . . available | (iv) is | (iv) is independently | SPAN | (b) . . . available to |
| to the Recipient | independently | developed by the | | the Recipient on a |
| on a non- | developed by the | receiving party | | non-confidential |
| confidential | receiving party | without reference to | | basis from a third- |
| basis from a | without reference to | the Confidential | | party source |
| third-party | the Confidential | information of the | | provided that such |
| source, as | information of the | other party. | | third party is not . . . |
| established by | other party, which | | | |
| documentary | can be | | | |
| evidence, | demonstrated by | | | |
| provided that | written record. | | | |
| such third party | | | | |
| is not . . . | | | | |
| (b) . . . available | (iii) was already in | (iii) was already in | SPAN | (b) . . . available to |
| to the Recipient | the possession of | the possession of the | | the Recipient on a |
| on a non- | the Recipient or its | Recipient or its | | non-confidential |
| confidential | Representatives (as | Representatives on a | | basis from a third- |
| basis from a | demonstrated by | non-confidential | | party source |
| third-party | written records) on | basis from a source | | provided that such |
| source, as | a non-confidential | other than the | | third party is not . . . |
| established by | basis from a source | Disclosing Parties | | |
| documentary | other than the | prior to the date | | |
| evidence, | Disclosing Parties | hereof . . . | | |
| provided that | prior to the date | | | |
| such third party | hereof . . . | | | |
| is not . . . | | | | |
| (b) . . . available | (c) was lawfully | (c) was lawfully | SPAN | (b) . . . available to |
| to the Recipient | acquired by the | acquired by the | | the Recipient on a |
| on a non- | Recipient from a | Recipient from a | | non-confidential |
| confidential | third party (as | third party and not | | basis from a third- |
| basis from a | evidenced in the | subject to any | | party source |
| third-party | Recipient's written | obligation of | | provided that such |
| source, as | records) and not | confidence to the | | third party is not . . . |
| established by | subject to any | party furnishing the | | |
| documentary | obligation of | Confidential | | |
| evidence, | confidence to the | Information. | | |
| provided that | party furnishing the | | | |
| such third party | Confidential | | | |
| is not . . . | Information. | | | |

### Full Edit Type Alignment

In some embodiments where the edit type comprises a full sentence insert (FSI), an alignment method may be selected based on the FSI edit type. Each SUA is compared to semantically similar original texts. If one of the original texts is labeled with an FSI edit operation, then that same FSI edit operation that was applied to the original text is applied to the SUA. An example of this alignment method for FSI edit operations is shown in Table C, below.

TABLE C

| SUA | Original Text | Final Text | Edit Op. | ESUA |
|---|---|---|---|---|
| Therefore, the | Any relief is in | Any relief is in | FSI | Therefore, the |
| Receiving Party | addition to and not | addition to and not | | Receiving Party |
| agrees that the | in replace of any | in replace of any | | agrees that the |
| Disclosing Party | appropriate relief in | appropriate relief in | | Disclosing Party |
| shall be entitled | the way of | the way of monetary | | shall be entitled to |
| to seek injunctive | monetary damages. | damages. Neither | | seek injunctive |
| and/or other | | Party shall be liable | | and/or other |
| equitable relief, | | for consequential | | equitable relief, in |
| in addition to | | damages. | | addition to any other |
| any other remedies | | | | remedies available at |
| available at law | | | | law or equity to the |
| or equity to the | | | | Disclosing Party. |
| Disclosing Party. | | | | Neither Party shall |
| | | | | be liable for |
| | | | | consequential damages. |
| Therefore, the | Therefore, the | Therefore, the | FSI | Therefore, the |
| Receiving Party | Disclosing Party | Disclosing Party | | Receiving Party |
| agrees that the | shall be entitled to | shall be entitled to | | agrees that the |
| Disclosing Party | seek equitable or | seek equitable or | | Disclosing Party |
| shall be entitled | injunctive relief, in | injunctive relief, in | | shall be entitled to |
| to seek injunctive | addition to other | addition to other | | seek injunctive |
| and/or other | remedies to which | remedies to which it | | and/or other |
| equitable relief, | it may be entitled at | may be entitled at | | equitable relief, in |
| in addition to | law or equity. | law or equity. | | addition to any |
| any other remedies | | Notwithstanding the | | other remedies |
| available at law | | foregoing, neither | | available at law or |
| or equity to the | | Party shall be liable | | equity to the |
| Disclosing Party. | | for consequential | | Disclosing Party. |
| | | damages. | | Neither Party shall |
| | | | | be liable for |
| | | | | consequential damages. |
| Therefore, the | Such remedies shall | Such remedies shall | FSI | Therefore, the |
| Receiving Party | not be deemed to be | not be deemed to be | | Receiving Party |
| agrees that the | the exclusive | the exclusive | | agrees that the |
| Disclosing Party | remedies for breach | remedies for breach | | Disclosing Party |
| shall be entitled | of this Agreement, | of this Agreement, | | shall be entitled to |
| to seek injunctive | but shall be in | but shall be in | | seek injunctive |
| and/or other | addition to all other | addition to all other | | and/or other |
| equitable relief, | remedies available | remedies available at | | equitable relief, in |
| in addition to | at law or in equity. | law or in equity. | | addition to any |
| any other remedies | | Neither Party shall | | other remedies |
| available at law | | be liable for | | available at law or |
| or equity to the | | consequential damages. | | equity to the |
| Disclosing Party. | | | | Disclosing Party. |
| | | | | Neither Party shall |
| | | | | be liable for |
| | | | | consequential damages. |

In some embodiments, if a single SUA triggers multiple FSI(s), semantically similar FSI(s) may be clustered together so that multiple FSIs aren't applied to the same SUA.

In some embodiments, the text of the paragraph/document/etc. can also be searched for semantically similar text to the FSI in order to ensure that the FSI isn't already in the DUA. A similar process can be used for full paragraph insertions and list editing. For example, where there is a full paragraph insertion edit operation indicated by the selected candidate original text, the system may check to make sure that the paragraph (or the context of the inserted paragraph) is not already in the DUA.

FSI may be added to the DUA in a location different from the SUA that triggered the FSI. In some embodiments, when an original text is an FSI and is selected as matching to the SUA, all similar FSI are also retrieved from the seed database. The document context is then considered to determine if any of that set of FSI's original texts are preferred, by frequency, over the SUA that triggered the FSI. If this is the case, and that original text or significantly similar text, occurs in the DUA, the FSI is placed after that new SUA, rather than the triggering SUA.

In some embodiments, another alignment method may be chosen where the edit type is a full sentence delete (FSD). Each SUA may be compared to semantically similar original texts. If one of the original texts is labeled with an FSD edit operation, then that same FSD edit operation that was applied to the original text is applied to the SUA. This same process can be done at the sentence, chunk, paragraph, etc. level, and an example of this alignment method for a FSD edit operation is shown in Table D below.

TABLE D

| | | | | |
|---|---|---|---|---|
| SUA | Original Text | Final Text | Edit Op. | ESUA |

| | | |
|---|---|---|
| If either | If either party | FSD |
| Disclosing Party | employs attorneys | |
| or Receiving | to enforce any | |
| Party employs | rights arising out of | |
| legal counsel to | or relating to this | |
| enforce any | Agreement, the | |
| rights arising | prevailing party | |
| out of or | shall be entitled to | |
| relating to this | recover reasonable | |
| Agreement, the | attorneys' fees and | |
| prevailing party | expenses. | |
| shall be entitled | | |
| to recover | | |
| reasonable | | |
| attorney's fees | | |
| and costs. | | |
| If either | The prevailing | FSD |
| Disclosing Party | Party in any action | |
| or Receiving | to enforce this | |
| Party employs | Agreement shall be | |
| legal counsel to | entitled to costs and | |
| enforce any | attorneys' fees. | |
| rights arising | | |
| out of or | | |
| relating to this | | |
| Agreement, the | | |
| prevailing party | | |
| shall be entitled | | |
| to recover | | |
| reasonable | | |
| attorney's fees | | |
| and costs. | | |
| If either | The prevailing | FSD |
| Disclosing Party | Party in any action | |
| or Receiving | to enforce this | |
| Party employs | Agreement shall be | |
| legal counsel to | entitled to all costs, | |
| enforce any | expenses and | |
| rights arising | reasonable | |
| out of or | attorneys' fees | |
| relating to this | incurred in bringing | |
| Agreement, the | such action. | |
| prevailing party | | |
| shall be entitled | | |
| to recover | | |
| reasonable | | |
| attorney's fees | | |
| and costs. | | |
| If either | Company agrees to | FSD |
| Disclosing Party | reimburse | |
| or Receiving | Disclosing Party | |
| Party employs | and its | |
| legal counsel to | Representatives for | |
| enforce any | all costs and | |
| rights arising | expenses, including | |
| out of or | reasonable | |
| relating to this | attorneys' fees, | |
| Agreement, the | incurred by them in | |
| prevailing party | enforcing the terms | |
| shall be entitled | of this Agreement. | |
| to recover | | |
| reasonable | | |
| attorney's fees | | |
| and costs. | | |

In some embodiments where there is a full paragraph edit type, an alignment method may be selected based on the full paragraph edit type. For example, in the case of a full paragraph insert, the system may cluster typically inserted paragraphs from training data/original texts according to textual similarity. The system may then select the most appropriate paragraph from the training data clusters by aligning paragraph features with the features of the DUA. Paragraph features may include information about the document that the paragraph was extracted from originally, such as, for example: counterparty, location in the document, document v. document similarity, nearby paragraphs, etc. In some embodiments, the system may further perform a presence check for the presence of the selected paragraph or highly similar paragraphs or text in the DUA. In some embodiments, the system may insert a paragraph using paragraph features in order to locate the optimal insertion location.

In some embodiments, another alignment method may be chosen where the edit type is a full paragraph delete (FPD). Each SUA may be compared to semantically similar original texts. If one of the original texts is labeled with an FPD edit operation, then that same FPD edit operation that was applied to the original text is applied to the SUA.

An example of this alignment method for a FPD edit operation is shown in Table E below.

TABLE E

| | | | | |
|---|---|---|---|---|
| SUA | Original Text | Final Text | Edit Op. | ESUA |

| | | |
|---|---|---|
| Each party | 11. Because an | FPD |
| recognizes that | award of money | |
| nothing in this | damages would be | |
| Agreement is | inadequate for any | |
| intended to limit | breach of this | |
| any remedy of | Agreement by the | |
| the other party. | Receiving Party, | |
| In addition, | the Receiving Party | |
| each party | agrees that in the | |
| agrees that a | event of any breach | |
| violation of this | of this Agreement, | |
| Agreement | the Disclosing | |
| could cause the | Party shall also be | |
| other party | entitled to equitable | |
| irreparable harm | relief. Such | |
| and that any | remedies shall not | |
| remedy at law | be the exclusive | |
| may be | remedies for any | |
| inadequate. | breach of this | |
| Therefore, each | Agreement, but | |
| party agrees that | shall be in addition | |
| the other party | to all other | |
| shall have the | remedies available | |
| right to an order | at law or equity. | |
| restraining any | | |
| breach of this | | |
| Agreement and | | |
| for any other | | |
| relief the non- | | |
| breaching party | | |
| deems | | |
| appropriate. | | |
| Each party | 5 Remedies. The | FPD |
| recognizes that | Company | |
| nothing in this | acknowledges that | |
| Agreement is | damages would not | |
| intended to limit | be an adequate | |
| any remedy of | remedy and that the | |
| the other party. | Seller and the | |
| In addition, | Target would be | |
| each party | irreparably harmed | |
| agrees that a | if any of the | |
| violation of this | provisions of this | |
| Agreement | letter agreement are | |
| could cause the | not performed | |
| other party | strictly in | |
| irreparable harm | accordance with | |
| and that any | their specific terms | |
| remedy at law | or are otherwise | |
| may be | breached. | |
| inadequate. | Accordingly, you | |
| Therefore, each | agree that each of | |
| party agrees that | the Seller and the | |
| the other party | Target is entitled, | |
| shall have the | individually or | |
| right to an order | together, to | |
| restraining any | injunctive relief (or | |
| breach of this | a similar remedy) to | |
| Agreement and | prevent breaches of | |
| for any other | this letter | |
| relief the non- | agreement and to | |
| breaching party | specifically enforce | |
| deems | its provisions in | |
| appropriate. | addition to any | |
| | other remedy | |
| | available to it at | |
| | law or in equity. | |
| Each party | Section 11. The | FPD |
| recognizes that | Receiving Party | |
| nothing in this | acknowledges that | |
| Agreement is | the Confidential | |
| intended to limit | Information is a | |
| any remedy of | valuable asset of | |
| the other party. | the Disclosing | |
| In addition, | Party. The | |
| each party | Receiving Party | |
| agrees that a | further | |
| violation of this | acknowledges that | |
| Agreement | the Disclosing | |
| could cause the | Party shall incur | |
| other party | irreparable damage | |
| irreparable harm | if the Receiving | |
| and that any | Party should breach | |
| remedy at law | any of the | |
| may be | provisions of this | |
| inadequate. | Agreement. | |
| Therefore, each | Accordingly, if the | |
| party agrees that | Receiving Party | |
| the other party | breaches any of the | |
| shall have the | provisions of this | |
| right to an order | Agreement, the | |
| restraining any | Disclosing party | |
| breach of this | shall be entitled, | |
| Agreement and | without prejudice, | |
| for any other | to all the rights, | |
| relief the non- | damages and | |
| breaching party | remedies available | |
| deems | to it, including an | |
| appropriate. | injunction | |
| | restraining any | |
| | breach of the | |
| | provisions of this | |
| | Agreement by the | |
| | Receiving Party or | |
| | its agents or | |
| | representatives. | |

### List Edit Type Alignment

In some embodiments where the edit type comprises a list edit type, an alignment method may be selected based on the list edit type.

As used herein, a leaf list may refer to an unstructured or non-enumerated list. One example of a leaf list is a list of nouns separated by a comma. In embodiments where there is a leaf list insert (LLI), the alignment method may comprise identifying a leaf list in the DUA, and tokenizing the leaf list into its constituent list items. The identified leaf list in the DUA is then compared to similar leaf lists in the training data of original texts. If a list item (e.g., in the case in table F below, “investor”) is being inserted in the original text, and the list item is not already an item in the leaf list in the DUA, then the list item is inserted in the leaf list in the DUA. An example of this alignment method for a LLI edit operation is shown in Table F below.

TABLE F

| SUA | Original Text | Final Text | Edit Op. | ESUA |
|---|---|---|---|---|
| “Representatives” | “Representative” | “Representative” | LLI | “Representatives” |
| means directors, | means the directors, | means the directors, | | means directors, |
| officers, employees, | officers, employees, | officers, employees, | | officers, employees, |
| leaders, agents, | investment bankers, | investment bankers, | | leaders, agents, |
| financial advisors, | rating agencies, | investors, rating | | financial advisors, |
| consultants, | consultants, counsel, | agencies, consultants, | | investors, consultants, |
| contractors, attorneys | and other representatives | counsel, and other | | contractors, attorneys |
| and accountants of a | of ADP or the Partner, | representatives of | | and accountants of a |
| Party or its Affiliate. | as applicable. | ADP or the Partner, | | Party or its Affiliate. |
| | | as applicable. | | |
| “Representatives” | “Representatives” | “Representatives” | LLI | “Representatives” |
| means directors, | means the | means the | | means directors, |
| officers, employees, | advisors, agents, | advisors, agents, | | officers, employees, |
| leaders, agents, | consultants, directors, | consultants, | | leaders, agents, |
| financial advisors, | officers, employees | directors, officers, | | financial advisors, |
| consultants, | and other representatives, | employees and | | investors, consultants, |
| contractors, attorneys | including accountants, | other representatives, | | contractors, attorneys |
| and accountants of a | auditors, financial | including accountants, | | and accountants of a |
| Party or its Affiliate. | advisors, lenders and | auditors, investors, | | Party or its Affiliate. |
| | lawyers of a Party. | financial advisors, | | |
| | | lenders and lawyers | | |
| | | of a Party. | | |
| “Representatives” | “Representatives” | “Representatives” | LLI | “Representatives” |
| means directors, | shall refer to all | shall refer to all | | means directors, |
| officers, employees, | of each respective | of each respective | | officers, employees, |
| leaders, agents, | Party's partners, | Party's partners, | | leaders, agents, |
| financial advisors, | officers, directors, | officers, directors, | | financial advisors, |
| consultants, | shareholders, employees, | shareholders, employees, | | investors, consultants, |
| contractors, attorneys | members, accountants, | members, accountants, | | contractors, attorneys |
| and accountants of a | attorneys, independent | investors, attorneys, | | and accountants of a |
| Party or its Affiliate. | contractors, temporary | independent contractors, | | Party or its Affiliate. |
| | employees, agents or | temporary employees, agents | | |
| | any other | or any | | |
| | representatives or | other representatives or | | |
| | persons that may | persons that may from | | |
| | from time to time | time to time be employed, | | |
| | be employed, retained | retained by, working for, | | |
| | by, working for, or | or acting on behalf of, | | |
| | acting on behalf | such Party. | | |
| | of, such Party. | | | |
| “Representatives” | “Representatives,” | “Representatives,” | LLI | “Representatives” |
| means directors, | with respect to | with respect to | | means directors, |
| officers, employees, | a party hereto means the | a party hereto means the | | officers, employees, |
| leaders, agents, | directors, officers, | directors, officers, | | leaders, agents, |
| financial advisors, | employees, advisors, | employees, advisors, | | financial advisors, |
| consultants, | consultants, bankers | consultants, bankers | | investors, consultants, |
| contractors, attorneys | (investment and commercial), | (investment and | | contractors, attorneys and |
| and accountants of a | lawyers, engineers, landmen, | commercial), investors, | | accountants of a |
| Party or its Affiliate. | geologists, geophysicists and | lawyers, engineers, landmen, | | Party or its Affiliate. |
| | accountants, of such party | geologists, geophysicists | | |
| | hereto or any Affiliate | and accountants, of such | | |
| | of such party hereto. | party hereto | | |
| | | or any Affiliate | | |
| | | of such party hereto. | | |

As another example, in embodiments where there is a leaf list deletion (LLD), the alignment method may comprise identifying a leaf list in the DUA and tokenizing the leaf list into its constituent list items. The identified leaf list in the DUA is then compared to similar leaf lists in the training data of original texts. If a list item (e.g., in the case in table G below, “employees”) is being deleted from the original text, and the list item is already an item in the leaf list in the DUA, then the list item is deleted in the leaf list in the DUA.

An example of this alignment method for a LLD edit operation is shown in Table G below.

TABLE G

| SUA | Original Text | Final Text | Edit Op. | ESUA |
|---|---|---|---|---|
| “Representatives” | “Representative” | “Representative” | LLD | “Representatives” |
| means directors, | means the directors, | means the directors, | | means directors, |
| officers, employees, | officers, employees, | officers, investment | | officers, leaders, |
| leaders, agents, | investment bankers, | bankers, rating | | agents, financial |
| financial advisors, | rating agencies, | agencies, | | advisors, |
| consultants, contractors, | consultants, | consultants, counsel, | | consultants, |
| attorneys and accountants | counsel, and other | and other | | contractors, |
| of a Party or its | representatives of | representatives of | | attorneys and |
| Affiliate. | ADP or the Partner, | ADP or the Partner, | | accountants of a |
| | as applicable. | as applicable. | | Party or its Affiliate. |
| “Representatives” | “Representatives” | “Representatives” | LLD | “Representatives” |
| means directors, | means the advisors, | means the advisors, | | means directors, |
| officers, employees, | agents, consultants, | agents, consultants, | | officers, leaders, |
| leaders, agents, financial | directors, officers, | directors, officers, | | agents, financial |
| advisors, consultants, | employees and | and other | | advisors, |
| contractors, attorneys | other | representatives, | | consultants, |
| and accountants of a | representatives, | including | | contractors, |
| Party or its Affiliate. | including | accountants, | | attorneys and |
| | accountants, | auditors, financial | | accountants of a |
| | auditors, financial | advisors, lenders and | | Party or its |
| | advisors, lenders | lawyers of a Party. | | Affiliate. |
| | and lawyers of a | | | |
| | Party. | | | |
| “Representatives” | “Representatives” | “Representatives” | LLD | “Representatives” |
| means directors, | shall refer to all of | shall refer to all of | | means directors, |
| officers, employees, | each respective | each respective | | officers, leaders, |
| leaders, agents, financial | Party's partners, | Party's partners, | | agents, financial |
| advisors, consultants, | officers, directors, | officers, directors, | | advisors, |
| contractors, attorneys and | shareholders, | shareholders, | | consultants, |
| accountants of a | employees, | members, | | contractors, |
| Party or its Affiliate. | members, | accountants, | | attorneys and |
| | accountants, | attorneys, | | accountants of a |
| | attorneys, | independent | | Party or its |
| | independent | contractors, | | Affiliate. |
| | contractors, | temporary | | |
| | temporary | employees, agents or | | |
| | employees, agents | any other | | |
| | or any other | representatives or | | |
| | representatives or | persons that may | | |
| | persons that may | from time to time be | | |
| | from time to time | employed, retained | | |
| | be employed, | by, working for, or | | |
| | retained by, | acting on behalf of, | | |
| | working for, or | such Party. | | |
| | acting on behalf of, | | | |
| | such Party. | | | |
| “Representatives” | “Representatives,” | “Representatives,” | LLD | “Representatives” |
| means directors, | with respect to a | with respect to a | | means directors, |
| officers, employees, | party hereto means | party hereto means | | officers, leaders, |
| leaders, agents, financial | the directors, | the directors, | | agents, financial |
| advisors, consultants, | officers, employees, | officers, advisors, | | advisors, |
| contractors, attorneys and | advisors, | consultants, bankers | | consultants, |
| accountants of a | consultants, | (investment and | | contractors, |
| Party or its Affiliate. | bankers (investment | commercial), | | attorneys and |
| | and commercial), | lawyers, engineers, | | accountants of a |
| | lawyers, engineers, | landmen, geologists, | | Party or its |
| | landmen, | geophysicists and | | Affiliate. |
| | geologists, | accountants, of such | | |
| | geophysicists and | party hereto or any | | |
| | accountants, of | Affiliate of such | | |
| | such party hereto or | party hereto. | | |
| | any Affiliate of | | | |
| | such party hereto. | | | |

As used herein, a “structured list” may refer to a structured or enumerated list. For example, a structured list may comprise a set of list items separated by bullet points, numbers ((i), (ii), (iii) . . . ), letters ((a), (b), (c) . . . ), and the like. In some embodiments where the edit type comprises a structured list insert (SLI), an alignment method may be selected based on the SLI edit type. According to the alignment method, each SUA comprising a structured list is compared to semantically similar original texts comprising a structured list. The aligning may further comprise tokenizing the structured lists in the SUA and the original text into their constituent list items. If one of the original texts is labeled with an LII edit operation, then the system determines the best location for insertion of the list item and the list item is inserted in the SUA to arrive at an ESUA. In some embodiments, the best location for insertion may be chosen by putting the inserted item next to the item already in the list it is most frequently collocated with. In other embodiments, the base location for insertion may be based on weights between nodes in a Markov chain model of the list or other graphical model of the sequence. In some embodiments, if a single SUA triggers multiple LIIs, semantically similar LIIs may be clustered together so that multiple semantically similar LIIs are not applied to the same SUA.

An example of this alignment method for a SLI edit operation is shown in Table H below.

TABLE H

| SUA | Original Text | Final Text | Edit Op. | ESUA |
|---|---|---|---|---|
| (a) in the public | 4.1 prior to its | 4.1 prior to its | SLI | (a) in the public |
| domain at the | disclosure was | disclosure was | | domain at the time |
| time of receipt | properly in | properly in | | of receipt by the |
| by the | Receiving Party's | Receiving Party's | | Receiving Party |
| Receiving Party | possession; or 4.2 is | possession; or 4.2 is | | through no breach of |
| through no | in the public | in the public domain | | this Agreement by |
| breach of this | domain through no | through no fault of | | the Receiving Party; |
| Agreement by | fault of the | the Receiving party; | | (b) independently |
| the Receiving | Receiving party; or | or 4.3 independently | | developed by or for |
| Party; (b) | 4.3 was lawfully | developed by or for | | the Receiving Party; |
| lawfully | known to the | the Receiving Party; | | (c) lawfully received |
| received by the | Receiving Party | or 4.4 was lawfully | | by the Receiving |
| Receiving Party | prior to disclosure; | known to the | | Party from a third |
| from a third | or 4.4 is lawfully | Receiving Party | | party; or (d) known |
| party; or (c) | made available to | prior to disclosure; | | by the Receiving |
| known by the | the Receiving Party | or 4.5 is lawfully | | Party at the time of |
| Receiving Party | by a third party | made available to | | receipt. |
| at the time of | entitled to disclose | the Receiving Party | | |
| receipt. | such information. | by a third party | | |
| | | entitled to disclose | | |
| | | such information. | | |
| (a) in the public | i.) Is publicly | i.) Is publicly known | SLI | (a) in the public |
| domain at the | known at the time | at the time of | | domain at the time |
| time of receipt | of Discloser's | Discloser's | | of receipt by the |
| by the | communication to | communication to | | Receiving Party |
| Receiving Party | Recipient or | Recipient or | | through no breach |
| through no | thereafter becomes | thereafter becomes | | of this Agreement |
| breach of this | publicly known | publicly known | | by the Receiving |
| Agreement by | through no | through no violation | | Party; (b) |
| the Receiving | violation of this | of this Agreement; | | independently |
| Party; (b) | Agreement; ii.) | ii.) Was lawfully in | | developed by or for |
| lawfully | Was lawfully in | Recipient's | | the Receiving Party; |
| received by the | Recipient's | possession free of | | (c) lawfully |
| Receiving Party | possession free of | any obligation of | | received by the |
| from a third | any obligation of | confidence at the | | Receiving Party |
| party; or (c) | confidence at the | time of Discloser's | | from a third party; |
| known by the | time of Discloser's | communication to | | or (d) known by the |
| Receiving Party | communication to | Recipient; iii.) Is | | Receiving Party at |
| at the time of | Recipient; or iii.) Is | rightfully obtained | | the time of receipt. |
| receipt. | rightfully obtained | by Recipient from a | | |
| | by Recipient from a | third party | | |
| | third party | authorized to make | | |
| | authorized to make | such disclosure; or | | |
| | such disclosure. | iv.) independently | | |
| | | developed by or for | | |
| | | the Recipient. | | |
| (a) in the public | (a) is or becomes | (a) is or becomes | SLI | (a) in the public |
| domain at the | available to the | available to the | | domain at the time |
| time of receipt | public other than by | public other than by | | of receipt by the |
| by the | breach of this | breach of this | | Receiving Party |
| Receiving Party | Agreement by | Agreement by | | through no breach |
| through no | Recipient; (b) | Recipient; (b) | | of this Agreement |
| breach of this | lawfully received | lawfully received | | by the Receiving |
| Agreement by | from a third party | from a third party | | Party; (b) |
| the Receiving | without restriction | without restriction | | independently |
| Party; (b) | on disclosure; (c) | on disclosure; (c) | | developed by or for |
| lawfully | disclosed by the | disclosed by the | | the Receiving Party; |
| received by the | Discloser to a third | Discloser to a third | | (c) lawfully |
| Receiving Party | party without a | party without a | | received by the |
| from a third | similar restriction | similar restriction on | | Receiving Party |
| party; or (c) | on the rights of | the rights of such | | from a third party; |
| known by the | such third party; (d) | third party; (d) | | or (d) known by the |
| Receiving Party | already known by | already known by | | Receiving Party at |
| at the time of | the Recipient | the Recipient | | the time of receipt. |
| receipt. | without breach of | without breach of | | |
| | this Agreement; or | this Agreement; (e) | | |
| | (e) approved in | independently | | |
| | writing by the | developed by or for | | |
| | Discloser for public | the Receiving Party; | | |
| | release or | or (f) approved in | | |
| | disclosure by the | writing by the | | |
| | Recipient. | Discloser for public | | |
| | | release or disclosure | | |
| | | by the Recipient. | | |

In embodiments where the edit type comprises a structured list deletion (SLD), the alignment method may compare the SUA to semantically similar original texts. If one of the original texts is labeled with an LII edit operation, then the best location for insertion of the list item is determined and the list item is inserted in the SAU to arrive at an ESUA. In some embodiments, if a single SUA triggers multiple LIIs, semantically similar LIIs may be clustered together so that multiple semantically similar LIIs are not applied to the same SUA.

An example of this alignment method for a SLD edit operation is shown in table I below.

TABLE I

| SUA | Original Text | Final Text | Edit Op. | ESUA |
|---|---|---|---|---|
| (a) in the public | 4.1 prior to its | 4.1 prior to its | SLD | (a) in the public |
| domain at the | disclosure was | disclosure was | | domain at the time |
| time of receipt | properly in | properly in | | of receipt by the |
| by the | Receiving Party's | Receiving Party's | | Receiving Party |
| Receiving Party | possession; or 4.2 is | possession; or 4.2 is | | through no breach of |
| through no | in the public | in the public domain | | this Agreement by |
| breach of this | domain through no | through no fault of | | the Receiving Party; |
| Agreement by | fault of the | the Receiving party; | | or (b) known by the |
| the Receiving | Receiving party; or | or 4.3 was lawfully | | Receiving Party at |
| Party; (b) | 4.3 was lawfully | known to the | | the time of receipt. |
| lawfully | known to the | Receiving Party | | |
| received by the | Receiving Party | prior to disclosure. | | |
| Receiving Party | prior to disclosure; | | | |
| from a third | or 4.4 is lawfully | | | |
| party; or (c) | made available to | | | |
| known by the | the Receiving Party | | | |
| Receiving Party | by a third party | | | |
| at the time of | entitled to disclose | | | |
| receipt. | such information. | | | |
| (a) in the public | i.) Is publicly | i.) Is publicly known | SLD | (a) in the public |
| domain at the | known at the time | at the time of | | domain at the time |
| time of receipt | of Discloser's | Discloser's | | of receipt by the |
| by the | communication to | communication to | | Receiving Party |
| Receiving Party | Recipient or | Recipient or | | through no breach |
| through no | thereafter becomes | thereafter becomes | | of this Agreement |
| breach of this | publicly known | publicly known | | by the Receiving |
| Agreement by | through no | through no violation | | Party; or (b) known |
| the Receiving | violation of this | of this Agreement; | | by the Receiving |
| Party; (b) | Agreement; ii.) | or ii.) Was lawfully | | Party at the time of |
| lawfully | Was lawfully in | in Recipient's | | receipt. |
| received by the | Recipient's | possession free of | | |
| Receiving Party | possession free of | any obligation of | | |
| from a third | any obligation of | confidence at the | | |
| party; or (c) | confidence at the | time of Discloser's | | |
| known by the | time of Discloser's | communication to | | |
| Receiving Party | communication to | Recipient. | | |
| at the time of | Recipient; or iii.) Is | | | |
| receipt. | rightfully obtained | | | |
| | by Recipient from a | | | |
| | third party | | | |
| | authorized to make | | | |
| | such disclosure. | | | |
| (a) in the public | (a) is or becomes | (a) is or becomes | SLD | (a) in the public |
| domain at the | available to the | available to the | | domain at the time |
| time of receipt | public other than by | public other than by | | of receipt by the |
| by the | breach of this | breach of this | | Receiving Party |
| Receiving Party | Agreement by | Agreement by | | through no breach |
| through no | Recipient; (b) | Recipient; (b) | | of this Agreement |
| breach of this | lawfully received | disclosed by the | | by the Receiving |
| Agreement by | from a third party | Discloser to a third | | Party; or (b) known |
| the Receiving | without restriction | party without a | | by the Receiving |
| Party; (b) | on disclosure; (c) | similar restriction on | | Party at the time of |
| lawfully | disclosed by the | the rights of such | | receipt. |
| received by the | Discloser to a third | third party; (c) | | |
| Receiving Party | party without a | already known by | | |
| from a third | similar restriction | the Recipient | | |
| party; or (c) | on the rights of | without breach of | | |
| known by the | such third party; (d) | this Agreement; or | | |
| Receiving Party | already known by | (d) approved in | | |
| at the time of | the Recipient | writing by the | | |
| receipt. | without breach of | Discloser for public | | |
| | this Agreement; or | release or disclosure | | |
| | (e) approved in | by the Recipient. | | |
| | writing by the | | | |
| | Discloser for public | | | |
| | release or | | | |
| | disclosure by the | | | |
| | Recipient. | | | |

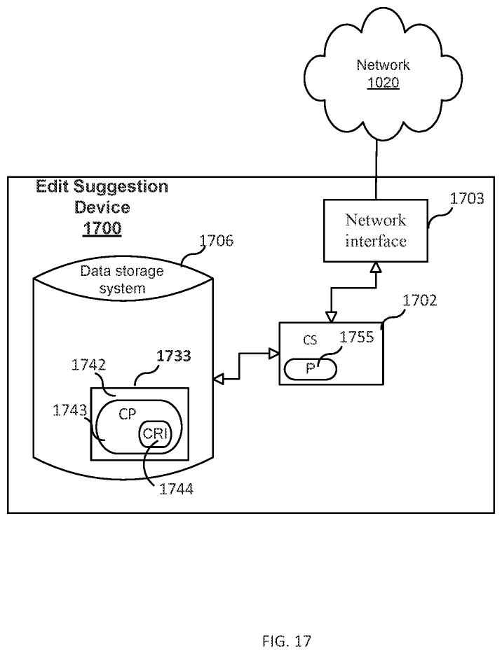

FIG. 17 is a block diagram illustrating an edit suggestion device according to some embodiments. In some embodiments, device 1700 is application server 1001. As shown in FIG. 17, device 1700 may comprise: a data processing system (DPS) 1702, which may include one or more processors 1755 (e.g., a general purpose microprocessor and/or one or more other data processing circuits, such as an application specific integrated circuit (ASIC), field-programmable gate arrays (FPGAs), and the like); a network interface 1703 for use in connecting device 1700 to network 1020; and local storage unit (a.k.a., “data storage system”) 1706, which may include one or more non-volatile storage devices and/or one or more volatile storage devices (e.g., random access memory (RAM)). In embodiments where device 1700 includes a general purpose microprocessor, a computer program product (CPP) 1733 may be provided. CPP 1733 includes a computer readable medium (CRM) 1742 storing a computer program (CP) 1743 comprising computer readable instructions (CRI) 1744. CRM 1742 may be a non-transitory computer readable medium, such as, but not limited, to magnetic media (e.g., a hard disk), optical media (e.g., a DVD), memory devices (e.g., random access memory), and the like. In some embodiments, the CRI 1744 of computer program 1743 is configured such that when executed by data processing system 1702, the CRI causes the device 1700 to perform steps described herein (e.g., steps described above and with reference to the flow charts). In other embodiments, device 1700 may be configured to perform steps described herein without the need for code. That is, for example, data processing system 1702 may consist merely of one or more ASICs. Hence, the features of the embodiments described herein may be implemented in hardware and/or software.

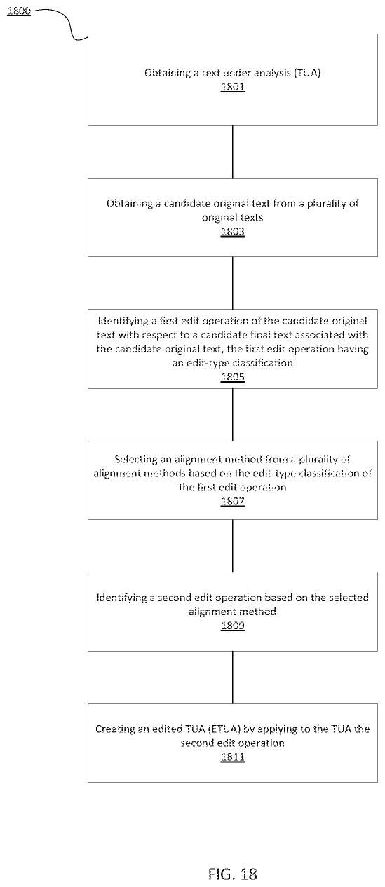

FIG. 18 is a method for suggesting revisions to text data, according to some embodiments. In some embodiments, the method 1800 may be performed by edit suggestion device 1700 or system 1000.

Step 1801 comprises obtaining a text under analysis (TUA). In some embodiments, the TUA may be a document-under-analysis (DUA) or a subset of the DUA, such as a statement-under-analysis (SUA).

Step 1803 comprises obtaining a candidate original text from a plurality of original texts. In some embodiments, step 1803 may comprise obtaining a first original text from the seed database for comparison against a SUA as described above in connection with FIG. 12, step 1210. As described above, different comparisons, or similarity metrics, may be determined based on an identified edit type in the first original text.

Step 1805 comprises identifying a first edit operation of the candidate original text with respect to a candidate final text associated with the candidate original text, the first edit operation having an edit-type classification. As discussed above, an edit operation may comprise, for example, a deletion, insertion, or replacement of text data in the candidate original text as compared to its associated candidate final text. The edit-type classification may comprise, for example, a point edit, span edit, list edit, full edit (e.g., FSI/FSD/FPI/FPD), or a chunk edit.

Step 1807 comprises selecting an alignment method from a plurality of alignment methods based on the edit-type classification of the first edit operation. For example, as described above, different alignment methods may be employed based on whether the edit type is a point, span, full, or list edit.

Step 1809 comprises identifying a second edit operation based on the selected alignment method. In some embodiments, the second edit operation may be the same as the first edit operation of the candidate original text (e.g., insertion or deletion of the same or semantically similar text).

Step 1811 comprises creating an edited TUA (ETUA) by applying to the TUA the second edit operation.

### Embodiments

### Group A Embodiments

A1. A computer-implemented method for editing of an electronic document with a prompt using a large language model (LLM), comprising:
(i) chunking a document under analysis (DUA) into paragraphs, sentences, lists, sub sentences, and/or meaningful pieces of text (SUA or sentence under analysis);
(ii) providing a seed database of edited and corresponding unedited text;
(iii) providing rules, wherein each set of edited and unedited text corresponds to a rule and wherein each rule corresponds to a prompt;
(iv) aligning SUAs using a similarity metric against the seed database; (v) inputting the SUA to an LLM with corresponding prompt;
(vi) receiving revised SUA generated by the LLM; and
(vii) suggesting an edit to the DUA based on the difference between the SUA and the revised SUA.

A2. The method according to embodiment A1, wherein the electronic document is a contract.

A3. The method according to embodiments A1 or A2, wherein the exemplary prompts include “Change the governing law to New York,” “Delete all supersedes language,” “Delete indemnification provision,” “Change term to 2 years,” and/or “Limit aggregate liability to two times contract amount of the preceding 12 month period.”

### Group B Embodiments

B1. A computer-implemented method for editing of an electronic document with a prompt using a large language model (LLM), comprising:
(i) chunking a document under analysis (DUA) into paragraphs, sentences, lists, sub sentences, and/or meaningful pieces of text (SUA or sentence under analysis);
(ii) providing a seed database of sets of edited and corresponding unedited text;
(iii) inputting each set of edited and corresponding unedited text to an LLM to generate a prompt;
(iv) providing rules, wherein each set of edited and unedited text corresponds to a rule and wherein each rule corresponds to a prompt;
(v) aligning SUAs using a similarity metric against the seed database;
(vi) inputting the SUA to an LLM with corresponding prompt;
(vii) receiving revised SUA generated by the LLM; and
(viii) suggesting an edit to the DUA based on the difference between the SUA and the revised SUA.

B2. The method according to embodiment B1, wherein the electronic document is a contract.

B3. The method according to embodiments B1 or B2, wherein the exemplary prompts include “Change the governing law to New York,” “Delete all supersedes language,” “Delete indemnification provision,” “Change term to 2 years,” and/or “Limit aggregate liability to two times contract amount of the preceding 12 month period.”

### Group C Embodiments

C1. A computer-implemented method for editing of an electronic document with examples as prompts using a large language model (LLM), comprising:
(i) chunking a document under analysis (DUA) into paragraphs, sentences, lists, sub sentences, and/or meaningful pieces of text (SUA or sentence under analysis);
(ii) providing a seed database of edited and corresponding unedited text;
(iii) aligning SUAs using a similarity metric against the seed database;
(iv) inputting all sentences from the seed database that align against the SUA to an LLM to prompt the LLM to edit the SUA;
(v) receiving revised SUA generated by the LLM; and
(vi) suggesting an edit to the DUA based on the difference between the SUA and the revised SUA.

### Group D Embodiments

D1. A computer-implemented method for editing of an electronic document using historical examples to make a classifier with a prompt per class using a large language model (LLM), comprising:
(i) chunking a document under analysis (DUA) into paragraphs, sentences, lists, sub sentences, and/or meaningful pieces of text (SUA or sentence under analysis);
(ii) providing a seed database of sentences and corresponding edited sentences;
(iii) clustering edits so that all similar edits are in the same cluster;
(iv) identifying a classifier for each cluster, wherein each class corresponds to a prompt;
(v) classifying each SUA by comparing each SUA against each classifier;
(vi) inputting classified SUA to an LLM with a corresponding prompt;
(vii) receiving revised SUA generated by the LLM; and
(viii) suggesting an edit to the DUA based on the difference between the SUA and the revised SUA.

### Group E Embodiments

E1. A computer-implemented method for editing of an electronic document with a prompt, by a user selecting preferred prompts via question and answer (Q&A), using a large language model (LLM), comprising:
(i) prompting a user to select one or more editing preferences;
(ii) chunking a document under analysis (DUA) into paragraphs, sentences, lists, sub sentences, and/or meaningful pieces of text (SUA or sentence under analysis);
(iii) providing a seed database of edited and corresponding unedited text based on the one or more editing preferences selected by the user;
(iv) providing rules, wherein each set of edited and unedited text corresponds to a rule and wherein each rule corresponds to a prompt;
(v) aligning SUAs using a similarity metric against the seed database;
(vi) inputting the SUA to an LLM with corresponding prompt;
(vii) receiving revised SUA generated by the LLM; and
(viii) suggesting an edit to the DUA based on the difference between the SUA and the revised SUA.

E2. The method according to embodiment E1, wherein the one or more editing preferences includes prompting the user to:
(a) indicate “Yes/No” to a prompt, such as “Yes/No: Are arbitration provisions permitted?”; and/or
(b) fill in the blank preference selection, such as “What is the preferred term: (a) 1 year; (b) 2 years; or (c) 3 years?”

### Group F Embodiments

F1. A computer-implemented method for editing of an electronic document with examples as prompts, by a user selecting preferred prompts via question and answer (Q&A), using a large language model (LLM), comprising:
(i) prompting a user to select one or more editing preferences;
(ii) chunking a document under analysis (DUA) into paragraphs, sentences, lists, sub sentences, and/or meaningful pieces of text (SUA or sentence under analysis);
(iii) providing a seed database of edited and corresponding unedited text based on the one or more editing preferences selected by the user;
(iv) aligning SUAs using a similarity metric against the seed database;
(v) inputting all sentences from the seed database that align against the SUA to an LLM to prompt the LLM to edit the SUA;
(vi) receiving revised SUA generated by the LLM; and
(vii) suggesting an edit to the DUA based on the difference between the SUA and the revised SUA.

F2. The method according to embodiment E1, wherein the one or more editing preferences includes prompting the user to:
(a) indicate “Yes/No” to a prompt, such as “Yes/No: Are arbitration provisions permitted?”; and/or
(b) fill in the blank preference selection, such as “What is the preferred term: (a) 1 year; (b) 2 years; or (c) 3 years?”

### Group G Embodiments

G1. A computer program comprising instructions which when executed by processing circuitry of a system, computer, device or node causes the system, computer, device or node to perform the method of any one of the embodiments of Groups A, B, C, D, E, and/or F.

### Group H Embodiments

H1. A carrier containing the computer program of embodiment G1, wherein the carrier is one of an electronic signal, an optical signal, a radio signal, and a computer readable storage medium.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context. It will be apparent to those skilled in the art that various modifications and variations can be made in the systems, methods, and computer program products disclosed herein.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

The following materials were originally included in the appendix, and are hereby incorporated by reference in their entirety.
U.S. Pat. No. 10,216,715
U.S. Pat. No. 10,515,149
U.S. Pat. No. 10,713,436
U.S. Pat. No. 11,244,110
U.S. patent application Ser. No. 17/592,588
U.S. Pat. No. 10,489,500
U.S. Pat. No. 10,824,797
U.S. Pat. No. 10,970,475
U.S. Pat. No. 11,093,697
U.S. patent application Ser. No. 17/376,907
U.S. Pat. No. 10,311,140
U.S. Pat. No. 10,614,157
U.S. patent application Ser. No. 17/562,352
https://aman.ai/primers/ai/transformers/·
http://www.columbia.edu/˜js12239/transformers.html
http://jalammar.github.io/illustrated-transformer/

1. A computer-implemented method for editing of an electronic document with a prompt using a large language model (LLM), comprising:
(i) chunking a document under analysis (DUA) into paragraphs, sentences, lists, sub sentences, and/or meaningful pieces of text (SUA or sentence under analysis);
(ii) providing a seed database of edited and corresponding unedited text;
(iii) providing rules, wherein each set of edited and unedited text corresponds to a rule and wherein each rule corresponds to a prompt;
(iv) aligning SUAs using a similarity metric against the seed database; (v) inputting the SUA to an LLM with corresponding prompt;
(vi) receiving revised SUA generated by the LLM; and
(vii) suggesting an edit to the DUA based on the difference between the SUA and the revised SUA.
